(19) United States
(12) Patent Application Publication
(10) Pub. No.: US 2026/0147850 A1
(43) Pub. Date: May 28, 2026

(54) PARAMETER ENGINEERING AND OPTIMIZATION APPROACH FOR EXTRACTING TARGETS FROM ROBUST DATASETS

(71) Applicant: Optum Services (Ireland) Limited, Dublin (IE)

(72) Inventors: Ciarán McKENNA, Dublin (IE); Breanndán O CONCHUIR, Killarney (IE); Evan Christopher DOLAN, Dublin (IE); Matthew ROBINSON, Greystones (IE); Eugene Edward FARRELL, Clarinbridge (IE); Kieran O'DONOGHUE, Dublin (IE)

(21) Appl. No.: 18/958,625

(22) Filed: Nov. 25, 2024

(51) Int. Cl. G06F 17/11; G06F 7/02

(52) U.S. Cl. CPC G06F 17/11; G06F 7/02

(57) ABSTRACT

Various embodiments of the present disclosure provide machine learning architectures and optimization techniques for improving predictive functionality of a computer. The techniques comprise generating a cohort-level optimization dataset with a plurality of entity-level predictive features and a plurality of feature-level predictive features for a plurality of entity data objects using a machine learning ensemble model. The techniques comprise identifying a plurality of iterative candidate outputs through a series of optimization iterations. During each optimization iteration, an iterative candidate output may be generated by applying optimization model and a constraint set combination to the cohort-level optimization dataset. The techniques comprise selecting a target output from the plurality of iterative candidate outputs based on selection criteria.

### BACKGROUND

Various embodiments of the present disclosure address technical challenges related to various optimization technologies and may be applied in various domains to improve computer-based optimization techniques through machine learning-based parameter engineering. Traditionally, optimization approaches for difference use cases are limited to observable parameters and fail to holistically optimize predictions across populations of entities. One example of this is in the healthcare domain, where a lack of predictive measures prevents healthcare providers from holistically targeting member populations across a plurality of applicable quality measures. Like the quality measures in a healthcare domain, many use cases rely on measures that are derived from varied and disparate calculation methods that are difficult to simulate outside of the real world. These measures present significant technical challenges to building optimization techniques for holistically evaluating a subset of entities. Because of these challenges, traditional approaches for optimizing the allocation of resources to improve across varied measures are constrained to single measures or smaller sets of measures that are related to each other. Some techniques apply a larger measure set; however, such techniques assess measures individually and fail to assess correlations between them.

Various embodiments of the present disclosure make important contributions to traditional optimization technologies by addressing these technical challenges, among others.

### BRIEF SUMMARY

### BRIEF DESCRIPTION OF THE DRAWINGS

FIG. 1 depicts an example overview of an architecture in accordance with some embodiments of the present disclosure.

FIG. 2 depicts an example predictive data analysis computing entity in accordance with some embodiments of the present disclosure.

FIG. 3 depicts an example client computing entity in accordance with some embodiments of the present disclosure.

FIG. 4 depicts a dataflow diagram showing example data structures and modules for optimizing an allocation of resources across an entity population in accordance with some embodiments of the present disclosure.

FIG. 5 depicts an operational example of a cohort-level optimization dataset in accordance with some embodiments of the present disclosure.

FIGS. 6A-B depict operational examples user interface screens for initiating one or more prediction-based actions of the present disclosure.

FIG. 7 depicts a flowchart diagram of an example process for optimizing target output in accordance with some embodiments of the present disclosure.

### DETAILED DESCRIPTION

Various embodiments of the present disclosure provide machine learning and optimization techniques that improve the predictive functionality of a computer by addressing the technical challenges discussed herein. These technical challenges lie in a lack of a unified and connected computing process that holistically addresses a plurality of real-world measures simultaneously, comprising the interdependencies between the different measures. To address this deficiency, the techniques of the present disclosure leverage a cohort-level optimization dataset that simultaneously models the plurality of real-world measures using a machine learning ensemble model and historical data. By doing so, an optimization model may be applied to one, universal dataset with a plurality of engineered parameters that holistically model a plurality of interrelated measures, to generate target outputs for various tasks, comprising the allocation of resources. In this way, some techniques of the present disclosure are designed to optimize resource allocations for complex measurement systems, such as STARs quality improvement metrics that combine clinical quality standards, member satisfaction, health plan performance, and compliance with operational standards all predicted using disparate prediction mechanism. Moreover, the cohort-level optimization dataset may be stored and continuously updated to monitor the state of a complex measurement system. By doing so, predictive parameter may be reused to generate real world insights, while reducing processing resources traditionally expended for optimization operations. These real-world insights may be leveraged in an iterative training process to continuously improve the machine learning and optimization models of the present disclosure.

More particularly, some embodiments of the present disclosure provide machine learning and optimization techniques that improve the predictive functionality of a computer. To do so, some embodiments of the present disclosure provide machine learning based parameter engineering techniques that may applied to improve the performance of optimization models designed for complex, multi-parameter prediction spaces. The machine learning based parameter engineering techniques may be performed using a machine learning ensemble model with a plurality of parameter-specific machine learning models. Each of these models may be iteratively trained using real world insights generated through an end-to-end optimization process. The end-to-end optimization process, for example, may encapsulate a plurality of engineered parameter within a cohort-level optimization dataset that may be stored and leveraged to generate target outputs. By doing so, the optimization process may allow for the efficient performance of a plurality of optimization iterations with different constraints to holistically identify target outputs. These target outputs may be leveraged to initiate various real-world actions, the results of which, may be used to improve the machine learning ensemble model. By doing so, embodiments of the present disclosure enable an end-to-end optimization process that provides improvements in the parameter engineering, model optimization, and predictive functionalities of a computer.

Some embodiments of the present disclosure provide improvements to parameter engineering that, when applied with downstream models, improve the predictive performance of a computer. The parameter engineering techniques, for example, may leverage a machine learning ensemble model with a plurality of parameter specific machine learning models. Each of the plurality of parameter specific machine learning models may be individually trained (and retrained) to generate a predictive parameter for an optimization model. By doing so, the machine learning ensemble model may enable the generation of a plurality predictive parameter that may be encapsulated within a single data structure, a cohort-level optimization dataset. Some embodiments of the present disclosure provide the machine learning based parameter engineering techniques as first stage of an optimization process, such that the plurality of predictive parameter may be leveraged by downstream models to improve an optimization process. Indeed, in some examples, the plurality of predictive parameter may be tailored to the optimization process to provide an end-to-end optimization process for a complex prediction domain.

In this way, some embodiments of the present disclosure provide improved optimization techniques that leverage an end-to-end optimization process to holistically assess a complex, multi-parameter, prediction space. The end-to-end optimization process leverages multi-dimensional parameter engineering techniques, at a first stage, to generate a cohort-level optimization dataset. Unlike traditional optimization techniques, the cohort-level optimization dataset holistically models a plurality of interrelated predictive parameters, comprising improvement measures that traditionally increase the complexity of an optimization problem. By doing so, the end-to-end optimization process may enable a guaranteed global minimum for optimization through the use of 0-1 integer linear programming. Ultimately, the end-to-end optimization process enables complex predictive insights (and multiple iterations thereof), while conserving processing, memory, and temporal resources.

In addition, or alternatively, some embodiments of the present disclosure provide improved training techniques for machine learning models. The improved training techniques, for example, may implement a real-world training feedback loop that is derived from optimized, targeted insights. For example, the end-to-end optimization process may implement a machine learning ensemble model as a first stage of an optimization process. By doing so, predictive parameters output by a plurality of models may be leveraged to generate a target output for initiating real-world actions. In some examples, real world observations may be recorded responsive to the real-world actions and leveraged to improve a plurality of training datasets for the machine learning ensemble model. In this way, the end-to-end optimization process may implement a feedback mechanism to iteratively improve the performance of the machine learning based parameter engineering techniques and, ultimately, the performance of the optimization process itself.

Examples of technologically advantageous embodiments of the present disclosure comprise improved: (i) parameter engineering techniques, (ii) optimization modeling techniques, (iii) training techniques, among other aspects of the present disclosure. Other technical improvements and advantages may be realized by one of ordinary skill in the art.

### I. Overview of Embodiments

As should be appreciated, various embodiments of the present disclosure may be implemented as methods, apparatus, systems, computing devices, computing entities, computer program products, and/or the like. As such, embodiments of the present disclosure may take the form of an apparatus, system, computing device, computing entity, and/or the like executing instructions stored on a computer-readable storage medium to perform certain steps or operations. Thus, embodiments of the present disclosure may take the form of an entirely hardware embodiment, an entirely computer program product embodiment, and/or an embodiment that comprises a combination of computer program products and hardware performing certain steps or operations.

Embodiments of the present disclosure are described below with reference to block diagrams and flowchart illustrations. Thus, it should be understood that each block of the block diagrams and flowchart illustrations may be implemented in the form of a computer program product, an entirely hardware embodiment, a combination of hardware and computer program products, and/or apparatus, systems, computing devices, computing entities, and/or the like carrying out instructions, operations, steps, and similar words used interchangeably (e.g., the executable instructions, instructions for execution, program code, and/or the like) on a computer-readable storage medium for execution. For example, retrieval, loading, and execution of code may be performed sequentially such that one instruction is retrieved, loaded, and executed at a time. In some example embodiments, retrieval, loading, and/or execution may be performed in parallel such that multiple instructions are retrieved, loaded, and/or executed together. Thus, such embodiments may produce specifically configured machines performing the steps or operations specified in the block diagrams and flowchart illustrations. Accordingly, the block diagrams and flowchart illustrations support various combinations of embodiments for performing the specified instructions, operations, or steps.

### II. Example Framework

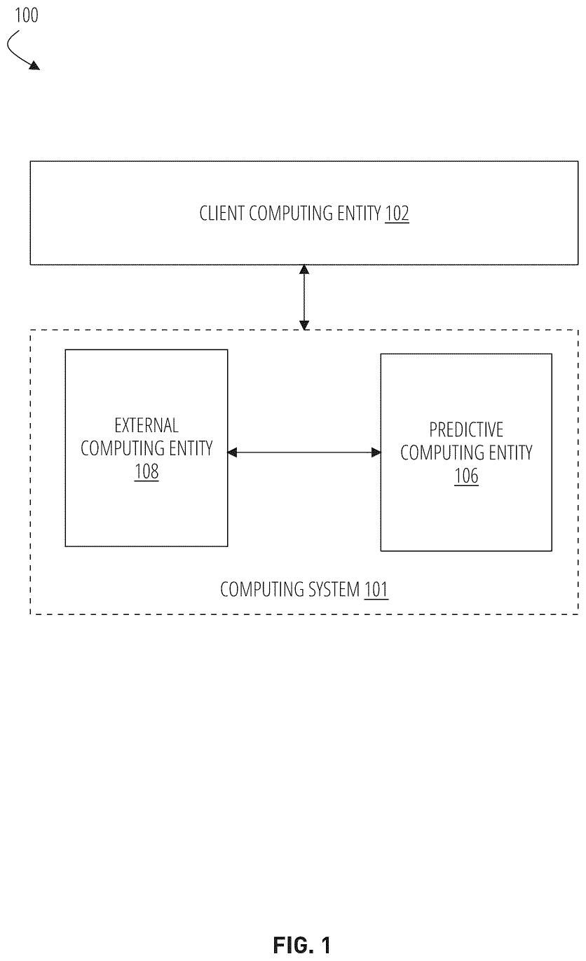

FIG. 1 depicts an example overview of an architecture 100 in accordance with some embodiments of the present disclosure. The architecture 100 comprises a computing system 101 configured to receive requests, such as resource allocation requests, from client computing entities 102, process the requests to generate target outputs, and provide the target outputs to the client computing entities 102. The example architecture 100 may be used in a plurality of domains and not limited to any specific application as disclosed herewith. The plurality of domains may comprise healthcare, industrial, manufacturing, computer security, to name a few.

In accordance with various embodiments of the present disclosure, one or more machine learning models may be trained to (i) generate predictive parameter for an optimization model, (ii) target outputs, and/or the like. The models may form a machine learning ensemble model that may be configured to engineer parameters for an optimization task. Some techniques of the present disclosure may adapt traditional models to a cohesive framework for more efficiently handling optimization processes.

In some embodiments, the computing system 101 may communicate with at least one of the client computing entities 102 using one or more communication networks. Examples of communication networks comprise any wired or wireless communication network comprising, for example, a wired or wireless local area network (LAN), personal area network (PAN), metropolitan area network (MAN), wide area network (WAN), or the like, as well as any hardware, software, and/or firmware required to implement it (such as, e.g., network routers, and/or the like).

The computing system 101 may comprise a predictive computing entity 106 and one or more external computing entities 108. The predictive computing entity 106 and/or one or more external computing entities 108 may be individually and/or collectively configured to receive requests from client computing entities 102, process the requests to generate a code predictions, and provide the code predictions to the client computing entities 102.

For example, as discussed in further detail herein, the predictive computing entity 106 and/or one or more external computing entities 108 comprise storage subsystems that may be configured to store input data, training data, and/or the like that may be used by the respective computing entities to perform predictive data analysis and/or training operations of the present disclosure. In addition, the storage subsystems may be configured to store model definition data used by the respective computing entities to perform various predictive data processing and/or training tasks. The storage subsystem may comprise one or more storage units, such as multiple distributed storage units that are connected through a computer network. A storage unit in the respective computing entities may store at least one of one or more data assets and/or a set of data about the computed properties of one or more data assets. Moreover, each storage unit in the storage systems may comprise one or more non-volatile storage or volatile storage media similar to or different than the non-volatile and/or volatile computer-readable storage media discussed above.

In some embodiments, the predictive computing entity 106 and/or one or more external computing entities 108 are communicatively coupled using one or more wired and/or wireless communication techniques. The respective computing entities may be configured according to the techniques described herein to perform one or more operations of one or more techniques described herein. By way of example, the predictive computing entity 106 may be configured to train, implement, use (e.g., execute an inference operation(s)), update (e.g., fine-tune), and evaluate machine learning models in accordance with one or more training and/or inference operations of the present disclosure. In some examples, the external computing entities 108 may be configured to train, implement, use, update, and evaluate machine learning models in accordance with one or more training and/or inference operations of the present disclosure.

In some embodiments, the predictive computing entity 106 may be configured to receive and/or transmit one or more datasets, objects, and/or the like from and/or to the external computing entities 108 to perform one or more steps/operations of one or more techniques (e.g., prediction techniques, optimization techniques, parameter engineering techniques, and/or the like) described herein. The external computing entities 108, for example, may comprise and/or be associated with one or more entities that may be configured to receive, transmit, store, manage, and/or facilitate datasets, such as a labelled training datasets, cohort-level optimization datasets, and/or the like. The external computing entities 108, for example, may comprise data sources that may provide such datasets, and/or the like to the predictive computing entity 106 which may leverage the datasets to perform one or more steps/operations of the present disclosure, as described herein. In some examples, the datasets may comprise an aggregation of data from across a plurality of external computing entities 108 into one or more aggregated datasets. The external computing entities 108, for example, may be associated with one or more data repositories, cloud platforms, compute nodes, organizations, and/or the like, which may be individually and/or collectively leveraged by the predictive computing entity 106 to obtain and aggregate data for a prediction domain.

In some example embodiments, the predictive computing entity 106 may be configured to receive a trained machine learning model trained and subsequently provided by the one or more external computing entities 108. For example, the one or more external computing entities 108 may be configured to perform one or more training steps/operations of the present disclosure to train a machine learning model, as described herein. In such a case, the trained machine learning model may be provided to the predictive computing entity 106, which may leverage the trained machine learning model to perform one or more inference steps/operations of the present disclosure. In some examples, feedback (e.g., evaluation data, ground truth data) from the use of the machine learning model may be received and/or stored by the predictive computing entity 106. In some examples, the feedback may be provided to the one or more external computing entities 108 to continuously train the machine learning model over time. In some examples, the feedback may be leveraged by the predictive computing entity 106 to continuously train the machine learning model over time. In this manner, the computing system 101 may perform, via one or more combinations of computing entities, one or more prediction, training, and/or any other machine learning-based techniques of the present disclosure.

### A. Example Predictive Computing Entity

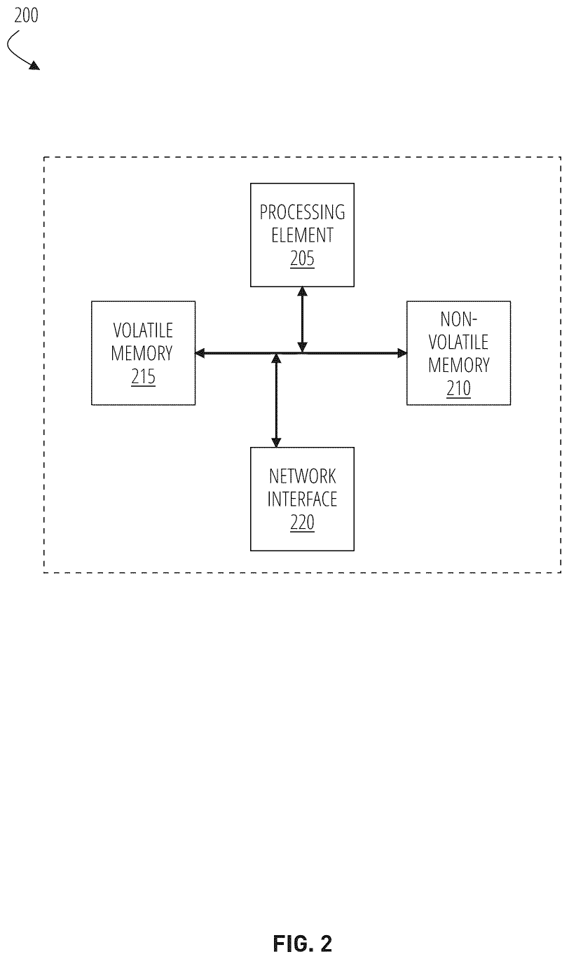

FIG. 2 depicts an example computing entity 200 in accordance with some embodiments of the present disclosure. The computing entity 200 is an example of the predictive computing entity 106 and/or external computing entities 108 of FIG. 1. In general, the terms computing entity, computer, entity, device, system, and/or similar words used herein interchangeably may refer to, for example, one or more computers, computing entities, desktops, mobile phones, tablets, phablets, notebooks, laptops, distributed systems, kiosks, input terminals, servers or server networks, blades, gateways, switches, processing devices, processing entities, set-top boxes, relays, routers, network access points, base stations, the like, and/or any combination of devices or entities adapted to perform the functions, operations, and/or processes described herein. Such functions, operations, and/or processes may comprise, for example, transmitting, receiving, operating on, processing, displaying, storing, determining, creating/generating, training one or more machine learning models, monitoring, evaluating, comparing, and/or similar terms used herein interchangeably. In some embodiments, these functions, operations, and/or processes may be performed on data, content, information, and/or similar terms used herein interchangeably. In some embodiments, the one computing entity (e.g., predictive computing entity 106) may train and use one or more machine learning models described herein. In other embodiments, a first computing entity (e.g., predictive computing entity 106, which may be one or more predictive computing entities) may use one or more machine learning models that may be trained by a second computing entity (e.g., external computing entity 108) communicatively coupled to the first computing entity. The second computing entity, for example, may train one or more of the machine learning models described herein, and subsequently provide the trained machine learning model(s) (e.g., optimized weights, code sets) to the first computing entity over a network.

As shown in FIG. 2, in some embodiments, the computing entity 200 may comprise, or be in communication with, one or more processing elements 205 (also referred to as processors, processing circuitry, and/or similar terms used herein interchangeably) that communicate with other elements within the computing entity 200 via a bus, for example. As will be understood, the processing element 205 may be embodied in a number of different ways.

For example, the processing element 205 may be embodied as one or more complex programmable logic devices (CPLDs), microprocessors, multi-core processors, arithmetic logic units (ALUs) (e.g., which may be part of one or more graphics processing units (GPUs), tensor processing units (TPUs), and/or the like), coprocessing entities, application-specific instruction-set processors (ASIPs), microcontrollers, and/or controllers. Additionally, or alternatively, the processing element 205 may be embodied as one or more other processing devices and/or circuitry. The term circuitry may refer to an entirely hardware embodiment or a combination of hardware and computer program products. Examples of a combination of hardware and computer program products comprise application specific integrated circuits (ASICs), field programmable gate arrays (FPGAs), programmable logic arrays (PLAs), hardware accelerators, other circuitry, and/or the like.

As will therefore be understood, the processing element 205 may be configured for a particular use or configured to execute instructions stored in volatile or non-volatile media or otherwise accessible to the processing element 205. As such, whether configured by hardware or computer program products, or by a combination thereof, the processing element 205 may be capable of performing steps or operations according to embodiments of the present disclosure when configured accordingly.

In some embodiments, the computing entity 200 may further comprise, or be in communication with, non-transitory computer readable media, such as non-volatile memory 210 (also referred to as non-volatile media, storage, memory storage, memory circuitry, and/or similar terms used herein interchangeably) and/or volatile memory 215 (also referred to as volatile media, storage, memory storage, memory circuitry, and/or similar terms used herein interchangeably), as discussed above.

In some embodiments, non-volatile memory 210 may comprise a computer-readable storage medium may comprise a floppy disk, flexible disk, hard disk, solid-state storage (SSS) (e.g., a solid-state drive (SSD), solid-state card (SSC), solid-state module (SSM)), enterprise flash drive, magnetic tape, or any other non-transitory magnetic medium, and/or the like. A non-volatile computer-readable storage medium may also comprise a punch card, paper tape, optical mark sheet (or any other physical medium with patterns of holes or other optically recognizable indicia), compact disc read only memory (CD-ROM), compact disc-rewritable (CD-RW), digital versatile disc (DVD), Blu-ray disc (BD), any other non-transitory optical medium, and/or the like. Such a non-volatile computer-readable storage medium may also comprise read-only memory (ROM), programmable read-only memory (PROM), erasable programmable read-only memory (EPROM), electrically erasable programmable read-only memory (EEPROM), flash memory (e.g., Serial, NAND, NOR, and/or the like), multimedia memory cards (MMC), secure digital (SD) memory cards, SmartMedia cards, CompactFlash (CF) cards, Memory Sticks, and/or the like. Further, a non-volatile computer-readable storage medium may also comprise conductive-bridging random access memory (CBRAM), phase-change random access memory (PRAM), ferroelectric random-access memory (FeRAM), non-volatile random-access memory (NVRAM), magnetoresistive random-access memory (MRAM), resistive random-access memory (RRAM), Silicon-Oxide-Nitride-Oxide-Silicon memory (SONOS), floating junction gate random access memory (FJG RAM), Millipede memory, racetrack memory, and/or the like.

In some embodiments, volatile memory 215 may comprise a computer-readable storage medium comprising random access memory (RAM), dynamic random access memory (DRAM), static random access memory (SRAM), fast page mode dynamic random access memory (FPM DRAM), extended data-out dynamic random access memory (EDO DRAM), synchronous dynamic random access memory (SDRAM), double data rate synchronous dynamic random access memory (DDR SDRAM), double data rate type two synchronous dynamic random access memory (DDR2 SDRAM), double data rate type three synchronous dynamic random access memory (DDR3 SDRAM), Rambus dynamic random access memory (RDRAM), Twin Transistor RAM (TTRAM), Thyristor RAM (T-RAM), Zero-capacitor (Z-RAM), Rambus in-line memory module (RIMM), dual in-line memory module (DIMM), single in-line memory module (SIMM), video random access memory (VRAM), cache memory (comprising various levels), flash memory, register memory, and/or the like. It will be appreciated that where embodiments are described to use a computer-readable storage medium, other types of computer-readable storage media may be substituted for or used in addition to the computer-readable storage media described above.

As will be recognized, the non-volatile memory 210 and/or the volatile memory 215 may store respective part(s) of one or more databases, database instances, database management systems, data, applications, programs, program modules, scripts, code (e.g., source code, object code, byte code, compiled code, interpreted code, machine code) that embodies one or more machine learning models or other computer functions described herein, executable instructions, and/or the like being executed by, for example, the processing element 205. The term database, database instance, database management system, and/or similar terms used herein interchangeably, may refer to a collection of records or data that is stored in a computer-readable storage medium using one or more database models; such as a hierarchical database model, network model, relational model, entity-relationship model, object model, document model, semantic model, graph model, and/or the like.

Thus, the databases, database instances, database management systems, data, applications, programs, program modules, code (source code, object code, byte code, compiled code, interpreted code, machine code) that embodies one or more machine learning models or other computer functions described herein, executable instructions, and/or the like may be used to control certain aspects of the operation of the computing entity 200 by operating the processing element 205 according to software component(s) retrieved from any of the computer-readable storage media and executed by the processing element 205.

Embodiments of the present disclosure may be implemented in various ways, comprising as computer program products that comprise articles of manufacture. Such computer program products may comprise one or more software components comprising, for example, software objects, methods, data structures, or the like. A software component may be coded in any of a variety of programming languages. An illustrative programming language may be a lower-level programming language such as an assembly language associated with a particular hardware architecture and/or operating system platform. A software component comprising assembly language instructions may require conversion into executable machine code by an assembler prior to execution by the hardware architecture and/or platform. Another example programming language may be a higher-level programming language that may be portable across multiple architectures. A software component comprising higher-level programming language instructions may require conversion to an intermediate representation by an interpreter or a compiler prior to execution.

Other examples of programming languages comprise, but are not limited to, a macro language, a shell or command language, a job control language, a script language, a database query or search language, and/or a report writing language. In one or more example embodiments, a software component comprising instructions in one of the foregoing examples of programming languages may be executed directly by an operating system or other software component without having to be first transformed into another form, such as object code, or may be first transformed into another form, such as by compiling source code. A software component may be stored as a file or other data storage construct. Software components of a similar type or functionally related may be stored together such as, for example, in a particular directory, folder, or library. Software components may be static (e.g., pre-established, or fixed) or dynamic (e.g., created or modified at the time of execution).

A computer program product may comprise a non-transitory computer-readable storage medium storing one or more software components comprising application(s), program(s), program module(s), script(s), source code and/or compiler(s) for generating executable instructions such as object code using the source code, program code, object code, byte code, compiled code, interpreted code, machine code, executable instructions, and/or the like (e.g., executable instructions, instructions for execution, computer program products, program code, and/or similar terms used herein interchangeably). Such non-transitory computer-readable storage media comprise all computer-readable storage media (comprising volatile memory 215 and non-volatile memory 210). In some embodiments, the computer program product may be executed by the computing entity 200 and/or the client computing entity. For example, at least a first portion of the computer program product may be stored within the volatile memory 215 and/or non-volatile 210 of the computing entity 200. In addition, or alternatively, at least a second portion of the computer program product may be stored within the volatile and/or non-volatile memory of a client computing entity.

As indicated, in some embodiments, the computing entity 200 may also comprise one or more network interfaces 220 for communicating with various computing entities (e.g., the client computing entity 102, external computing entities), such as by communicating data, code, content, information, and/or similar terms used herein interchangeably that may be transmitted, received, operated on, processed, displayed, stored, and/or the like. Such communication may be executed using a wired data transmission protocol, such as fiber distributed data interface (FDDI), digital subscriber line (DSL), Ethernet, asynchronous transfer mode (ATM), frame relay, data over cable service interface specification (DOCSIS), or any other wired transmission protocol. In some embodiments, the computing entity 200 communicates with another computing entity for uploading or downloading data or code (e.g., data or code that embodies or is otherwise associated with one or more machine learning models). Similarly, the computing entity 200 may be configured to communicate via wireless external communication networks using any of a variety of protocols, such as general packet radio service (GPRS), Universal Mobile Telecommunications System (UMTS), Code Division Multiple Access 2000 (CDMA2000), CDMA2000 1× (1×RTT), Wideband Code Division Multiple Access (WCDMA), Global System for Mobile Communications (GSM), Enhanced Data rates for GSM Evolution (EDGE), Time Division-Synchronous Code Division Multiple Access (TD-SCDMA), Long Term Evolution (LTE), Evolved Universal Terrestrial Radio Access Network (E-UTRAN), Evolution-Data Optimized (EVDO), High Speed Packet Access (HSPA), High-Speed Downlink Packet Access (HSDPA), IEEE 802.11 (Wi-Fi), Wi-Fi Direct, IEEE 802.16 (WiMAX), ultra-wideband (UWB), infrared (IR) protocols, near field communication (NFC) protocols, Wibree, Bluetooth protocols, wireless universal serial bus (USB) protocols, and/or any other wireless protocol.

Although not shown, the computing entity 200 may additionally or alternatively comprise, or be in communication with, one or more input elements/devices, such as input sensor(s). In some examples, the input sensor(s) may comprise one or more keyboards, pointing devices (e.g., mouse, trackpad), touch screens, cameras (e.g., infrared light camera, visual light camera), depth sensors (e.g., LIDAR, radar, stereo cameras), gyroscopes, location sensors (e.g., global positioning system (GPS), Hall effect sensor, laser doppler vibrometer), microphones, and/or the like. The computing entity 200 may additionally or alternatively comprise, or be in communication with, one or more output elements/devices (not shown), such as one or more speakers, visual display devices, haptic feedback devices, motion devices (e.g., electromechanically actuated devices), and/or the like.

### B. Example Client Computing Entity

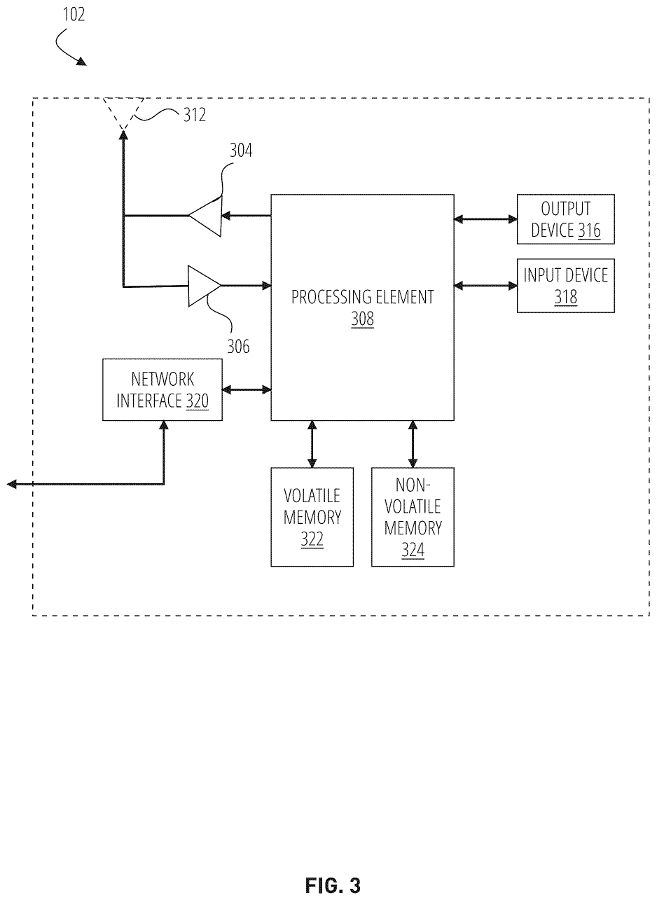

FIG. 3 depicts an example client computing entity in accordance with some embodiments of the present disclosure. In general, the terms device, system, computing entity, entity, and/or similar words used herein interchangeably may refer to, for example, one or more computers, computing entities, desktops, mobile phones, tablets, phablets, notebooks, laptops, distributed systems, kiosks, input terminals, servers or server networks, blades, gateways, switches, processing devices, processing entities, set-top boxes, relays, routers, network access points, base stations, the like, and/or any combination of devices or entities adapted to perform the functions, operations, and/or processes described herein. Client computing entities 102 may be operated by various parties. As shown in FIG. 3, the client computing entity 102 may comprise an antenna 312, a transmitter 304 (e.g., radio), a receiver 306 (e.g., radio), and a processing element 308 (e.g., CPLDs, microprocessors, multi-core processors, coprocessing entities, ASIPs, microcontrollers, and/or controllers) that provides signals to and receives signals from the transmitter 304 and receiver 306, correspondingly.

The signals provided to and received from the transmitter 304 and the receiver 306, correspondingly, may comprise signaling information/data in accordance with air interface standards of applicable wireless systems. In this regard, the client computing entity 102 may be capable of operating with one or more air interface standards, communication protocols, modulation types, and access types. More particularly, the client computing entity 102 may operate in accordance with one or more wireless and/or wired communication standards and protocols, such as those described above with regard to the computing entity 200.

The client computing entity 102 may additionally or alternatively download code, changes, add-ons, and updates, for instance, to its firmware, software (e.g., comprising executable instructions, applications, program modules), and operating system.

According to some embodiments, the client computing entity 102 may comprise location determining aspects, devices, modules, functionalities, and/or similar words used herein interchangeably. For example, the client computing entity 102 may comprise outdoor positioning aspects, such as a location component adapted to acquire, for example, latitude, longitude, altitude, geocode, course, direction, heading, speed, universal time (UTC), date, and/or various other information/data. In some embodiments, the location component may acquire data, sometimes known as ephemeris data, by identifying the number of satellites in view and the relative positions of those satellites (e.g., using global positioning systems (GPS)). The satellites may be a variety of different satellites, comprising Low Earth Orbit (LEO) satellite systems, Department of Defense (DOD) satellite systems, the European Union Galileo positioning systems, the Chinese Compass navigation systems, Indian Regional Navigational satellite systems, and/or the like. This data may be collected using a variety of coordinate systems, such as the DecimalDegrees (DD); Degrees, Minutes, Seconds (DMS); Universal Transverse Mercator (UTM); Universal Polar Stereographic (UPS) coordinate systems; and/or the like. Alternatively, the location information/data may be determined by triangulating the position of the client computing entity 102 in connection with a variety of other systems, comprising cellular towers, Wi-Fi access points, and/or the like. Similarly, the client computing entity 102 may comprise indoor positioning aspects, such as a location component adapted to acquire, for example, latitude, longitude, altitude, geocode, course, direction, heading, speed, time, date, and/or various other information/data. Some of the indoor systems may use various position or location technologies comprising RFID tags, indoor beacons or transmitters, Wi-Fi access points, cellular towers, nearby computing devices (e.g., smartphones, laptops), and/or the like. For instance, such technologies may comprise the iBeacons, Gimbal proximity beacons, Bluetooth Low Energy (BLE) transmitters, NFC transmitters, and/or the like. These indoor positioning aspects may be used in a variety of settings to determine the location of someone or something to within inches or centimeters.

The client computing entity 102 may also comprise a user interface that may comprise an output device 316 coupled to a processing element 308 and/or a user input device 318 coupled to the processing element 308. An output device 316, for example, may comprise a hardware computing device comprising one or more output elements (not shown), such as one or more speakers, visual display devices, haptic feedback devices, motion devices (e.g., electromechanically actuated devices), and/or the like. A user input device 318 may comprise the same or different hardware computing device comprising one or more input elements (not shown), such as keyboards, pointing devices (e.g., mouse, trackpad), touch screens, cameras (e.g., infrared light camera, visual light camera), depth sensors (e.g., LIDAR, radar, stereo cameras), gyroscopes, location sensors (e.g., global positioning system (GPS), Hall effect sensor, laser doppler vibrometer), microphones, and/or the like.

In some examples, the user interface may additionally or alternatively comprise software component(s) executed by the processing element 308 to present (e.g., audibly, visually, tactilely) via a user input device 318 and/or output device 316 and/or a software endpoint such as an application programming interface (API) or exposed software function a graphical user interface (GUI) (e.g., at least a portion of a user application, browser), command-line interface, touch and/or haptic user interface, gesture and/or image capture-based interface, voice/audio user interface, and/or the like used herein interchangeably executing on and/or accessible via the client computing entity 102 to interact with and/or cause display of information/data from the computing entity 200, as described herein. In addition to providing input, the user input interface may be used, for example, to activate, deactivate, and/or modify certain functions, such as altering a power or operating state of the client computing entity 102, the computing system 101, the predictive computing entity 106, and/or the external computing entity 108.

The client computing entity 102 may further comprise, or be in communication with, one or more memory components, such as the volatile memory 322 and/or non-volatile memory 324. For example, the memory components may comprise non-transitory computer readable media, such as non-volatile memory 324 (also referred to as non-volatile storage, memory, memory storage, memory circuitry, and/or similar terms used herein interchangeably) and/or volatile memory 322 (also referred to as volatile storage, memory, memory storage, memory circuitry, and/or similar terms used herein interchangeably), as discussed above with reference to FIG. 2.

As will be recognized, the non-volatile memory 324 and/or the volatile memory 322 may store respective part(s) of one or more databases, database instances, database management systems, data, applications, programs, program modules, scripts, code (e.g., source code, object code, byte code, compiled code, interpreted code, machine code) that embodies one or more machine learning models or other computer functions described herein, executable instructions, and/or the like being executed by, for example, the processing element 308. The term database, database instance, database management system, and/or similar terms used herein interchangeably, may refer to a collection of records or data that is stored in a computer-readable storage medium using one or more database models; such as a hierarchical database model, network model, relational model, entity-relationship model, object model, document model, semantic model, graph model, and/or the like.

In another embodiment, the client computing entity 102 may comprise one or more components or functionalities that are the same or similar to those of the computing entity 200, as described in greater detail above. In one such embodiment, the client computing entity 102 downloads, e.g., via network interface 320, code embodying machine learning model(s) from the computing entity 200 so that the client computing entity 102 may run a local instance of the machine learning model(s). As will be recognized, these architectures and descriptions are provided for example purposes only and are not limited to the various embodiments.

In various embodiments, the client computing entity 102 may be embodied as an artificial intelligence (AI) computing entity (e.g., an intelligent agent machine-learned model), such as AutoGPT, Mycroft, Rhasspy, and/or the like. Accordingly, the client computing entity 102 may be configured to provide and/or receive information/data from a user via an input/output mechanism, such as a display, a camera, a speaker, a voice-activated input, and/or the like. In certain embodiments, an AI computing entity may comprise one or more predefined and executable program algorithms stored within an onboard memory storage component, and/or accessible over a network. In various embodiments, the AI computing entity may be configured to retrieve and/or execute one or more of the predefined program algorithms upon the occurrence of a predefined trigger event.

### V. Example System Operations

As indicated, various embodiments of the present disclosure make important technical contributions to computer functionality. In particular, systems and methods are disclosed herein that implement machine learning and optimization techniques to improve machine learning model performance with respect to various tasks, comprising multi-parameter optimization. By doing so, the machine learning and optimization techniques of the present disclosure enables improved machine learning and optimization models that, when executed on a computer, reduce the processing, memory, and temporal requirement for various computing tasks. This, in turn, may improve the functionality of a computer with respect to various computing tasks, comprising computer security, classification prediction, and the like.

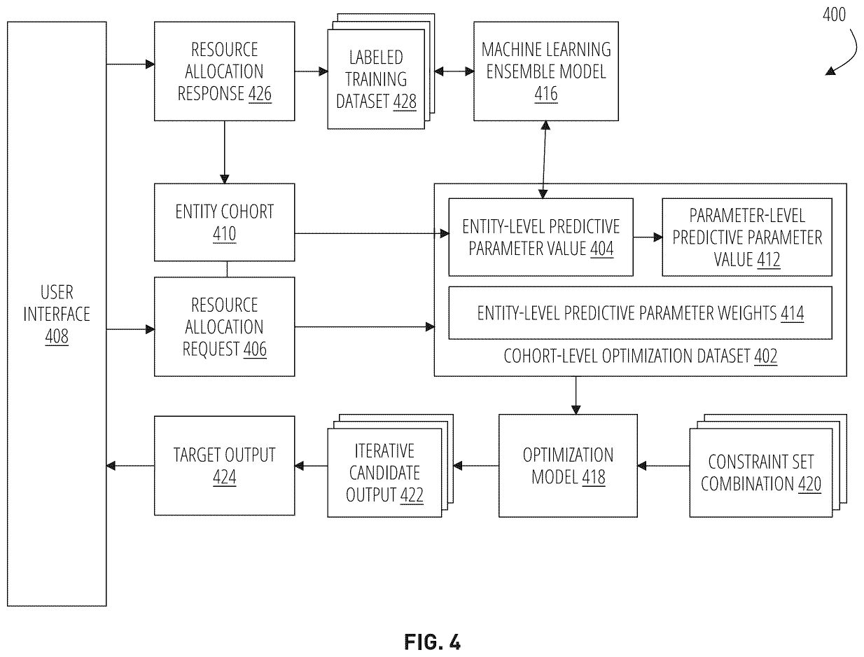

FIG. 4 depicts a dataflow diagram 400 showing example data structures and modules for optimizing an allocation of resources across an entity population in accordance with some embodiments of the present disclosure. The dataflow diagram 400 shows a iterative, training feedback loop that is applied to generate predictive parameter values for a cohort-level optimization dataset 402. Each of the predictive parameter values may be generated by models trained using labeled training datasets 428 that are continuously updated based on real world observations. The predictive parameter values, in combination with other parameters defined by the cohort-level optimization dataset 402, may be leveraged by an optimization model 418 to iteratively generate iterative candidate outputs 422 aimed to optimize the allocation of finite resources. By doing so, a target output 424 may be identified and used to allocate finite resources and real-world observations resulting from the allocations may be used as feedback to improve the predictive parameter values of the cohort-level optimization dataset 402. In this manner, the iterative, training feedback loop of the dataflow diagram 400 may integrate machine learning and optimization techniques to synthesize machine learning outputs into actionable, continuously improving, computer insights.

In some embodiments, a resource allocation request 406 is received via a user interface 408 accessible to a user device. The resource allocation request 406 may comprise a cohort identifier. In some examples, the set of entity data objects of an entity cohort 410 may be identified based on the cohort identifier.

In some embodiments, the resource allocation request 406 is a data message that describes a request for a performance of an optimization process. The resource allocation request 406, for example, may identify an entity cohort 410 and request an identification of a subset of the entity cohort for allocation of a finite set of resources. In some examples, the resource allocation request 406 may comprise a cohort identifier that identifies the entity cohort 410. A cohort identifier, for example, may comprise a group identifier, contract identifier, plan identifier, and/or the like that corresponds to a set of entities within an entity population. In some examples, the resource allocation request 406 may comprise a prediction resource that identifies a resource for distribution from the finite set of resources. A prediction resource, for example, may comprise an outreach program (e.g., a house call, etc.), a processing resource, and/or the like depending on the prediction domain.

The resource allocation request 406 may be based on a prediction domain. For example, in a clinical domain, a resource allocation request 406 may comprise a request to identify a subset of patients from a health care plan that may improve the health care plan to the highest degree available given a finite set of financial and/or temporal resources. By way of example, a resource allocation request 406 may comprise a request to identify a subset of patients for an outreach program with limited capabilities. In other prediction domains, such a computer processing domain, a resource allocation request 406 may comprise a request to identify a subset of computing tasks that may optimize computing performance given a finite set of computer resources (e.g., processing and memory capacity, etc.).

In some embodiments, the entity cohort 410 is a data entity that describes a group of entities from an entity population. An entity cohort 410, for example, may describe a set of entity data objects. Each entity data object may comprise a plurality of entity attributes respectively corresponding to an entity corresponding to the entity data object. The set of entity data objects and/or entity attributes thereof may be based on a prediction domain. For instance, an entity data object may correspond to a patient in a clinical domain and the plurality of attributes may comprise electronic health record data. In addition, or alternatively, an entity data object may correspond to a computer process in a computing domain and the plurality of attributes may comprise computing characteristics of the computer process, such as size, number of sub-processes, messaging protocols, and/or the like. In some examples, an entity data object of an entity cohort 410 may be referenced as, i, in one or more optimization techniques of the present disclosure.

In some embodiments, a cohort-level optimization dataset 402 is generated that comprises an entity-level predictive parameter value 404 and a parameter-level predictive parameter value 412 for an entity data object. In some examples, the cohort-level optimization dataset 402 may comprise an of entity-level predictive parameter weight 414.

In some embodiments, a cohort-level optimization dataset 402 is an engineered parameter dataset for an entity cohort 410. The cohort-level optimization dataset 402, for example, may comprise a relational database, a graph database, and/or any other data structure configured to store a plurality of predictive features for the entity cohort 410. In some examples, at least a portion of the plurality of predictive features may be stored at an entity and/or feature level to allow for reusability of the predictive features for other optimization techniques. In this manner, the cohort-level optimization dataset 402 may reduce memory usage requirements for complex optimization tasks.

In some embodiments, the cohort-level optimization dataset 402 may model one or more dependencies between a plurality of predictive parameters. The cohort-level optimization dataset 402, for example, may comprise a set of entity data objects, a plurality of entity-level predictive parameter values 404, a plurality of entity-level predictive parameter weights 414 respectively corresponding to the plurality of entity-level predictive parameter values 404, one or more parameter-level predictive parameter values 412, and/or one or more interdependent thresholds, such as parameter-level cutoff thresholds, and/or the like. As described herein, the predictive parameters and the interdependent relationships modeled by cohort-level optimization dataset 402 may be leveraged by an optimization model 418 to select a subset of set of entity data objects and/or predictive parameters values thereof for a particular predictive task. By modeling the predictive parameters and the interdependent relationships, the cohort-level optimization dataset 402 may improve the accuracy and speed of the optimization model 418, while allowing for holistic predictions at a fraction of the cost of traditional techniques.

In some embodiments, the predictive parameter is a parameter of an optimization model that is modeled by a cohort-level optimization dataset 402. A predictive parameter, for example, may define a measure type that may contribute to an optimized solution. A predictive parameter may be domain specific. For instance, in a healthcare domain, a predictive parameter may comprise a quality measure for a STARs rating system. In other examples, a predictive parameter may comprise an engagement measure for predicting a likelihood that an entity will engage if allocated a resource. In yet other examples, in computer domain, a predictive parameter may comprise an efficiency measure for a central processing unit.

A cohort-level optimization dataset 402 may comprise an entity-level predictive parameter value 404 and/or a parameter-level predictive parameter value 412 for a predictive parameter of a plurality of predictive parameters. For example, a cohort-level optimization dataset 402 may comprise an entity-level predictive parameter value for an entity-parameter combination, such that an entity data object of the cohort-level optimization dataset 402 may be associated with an entity-level predictive parameter value for a predictive parameter (e.g., in some case each of the predictive parameters). In addition, or alternatively, the cohort-level optimization dataset 402 may comprise a feature-level predictive parameter value for a predictive parameter that describes an attribute for the predictive parameter, as described herein.

In some embodiments, one or more entity-level predictive parameter values 404 are generated for an entity data object of the set of entity data objects based on one or more entity attributes of the entity data object. The entity-level predictive parameter values 404 may be generated using a machine learning ensemble model 416. In some examples, the machine learning ensemble model 416 may comprise an engagement prediction model and/or a plurality of activity-specific prediction models that may be trained using one or more labeled training datasets 428. In some examples, the one or more labeled training datasets 428 May comprise a labeled training dataset and a plurality of activity-specific labeled training datasets. The engagement prediction model may be trained using the labeled training dataset. In addition, or alternatively, an activity-specific prediction model of the plurality of activity-specific prediction models may be trained, using one or more supervisory training techniques, based on an activity-specific labeled training dataset of the plurality of activity-specific labeled training datasets.

In some embodiments, the entity-level predictive parameter value is a value of a predictive parameter with respect to an entity data object of an entity cohort 410. An entity-level predictive parameter value may comprise a binary value and/or a unit interval (e.g., between 0 and 1, etc.). In some examples, an entity-level predictive parameter value may comprise a binary value that represents whether an entity is predicted to perform an activity defined by a predictive parameter. By way of example, an entity-level predictive parameter value may comprise an activity-based predictive parameter value, oᵢⱼ∈{0,1}, that represents whether an activity has been observed or is predicted to occur to modify a gap status (closed/open) for an entity, i, within an activity-based predictive parameter, j. The activity-based predictive parameter value may be reflective of an observed, current status for an entity at a point in time, or a predicted status for the entity. In some examples, the predicted status may be based on an activity specific score that may be generated by a machine learning model, such as the activity specific prediction models of the present disclosure.

In addition, or alternatively, an entity-level predictive parameter value may comprise an engagement-based predictive parameter value, pᵢ, that represents a probability that an entity will engage with an allocation of a resource. In some examples, the engagement-based predictive parameter value may be based on an engagement score that may be generated by a machine learning model, such as an engagement specific prediction model of the present disclosure.

In some embodiments, the activity specific score is a predictive probability of an entity-level predictive parameter value for a predictive parameter. The activity specific score, for example, may be an output from a machine learning model that is configured to predict a likelihood that an entity will perform an activity defined by a predictive parameter in response to a resource and based on one or more attributes of the entity data object. For instance, an activity specific score, pᵢⱼ, may represent a probability of an intervention (e.g., a resource), closing a gap for an entity, i, within the predictive parameter, j. An example of this, for a healthcare domain may comprise an output from a machine learning model that predicts the probability of a gap closure resulting from a house call intervention. In some examples, an activity specific score may be converted to an entity-level predictive parameter value by assigning a 0 or a 1 to the activity specific score based on a threshold value (e.g., 0.8, etc.).

In some embodiments, an engagement score is a predictive probability of an entity-level predictive parameter value for a predictive parameter. The engagement score, for example, may be an output from a machine learning model that is configured to predict a likelihood that an entity will engage with a resource based on one or more attributes of the entity data object. In some examples, an engagement score may be assigned to an entity as a unit interval entity-level predictive parameter value.

In some embodiments, the historical entity-level predictive parameter score is a historical value of a predictive parameter with respect to an entity of an entity cohort 410.

In some embodiments, a machine learning ensemble model 416 is a data entity that describes parameters, hyper-parameters, and/or defined operations of a rules-based and/or machine learning model (e.g., model comprising at least one of one or more rule-based layers, one or more layers that depend on trained parameters, coefficients, and/or the like). The machine learning ensemble model 416 may comprise any type of model configured, trained, and/or the like to generate a plurality of engineered parameters and/or parameter values for an entity cohort 410. The machine learning ensemble model 416 may comprise one or more of any type of machine learning model comprising one or more supervised, unsupervised, semi-supervised, reinforcement learning models, and/or the like. In some examples, the machine learning ensemble model 416 may comprise a plurality of component machine learning models. In some examples, the plurality of component machine learning models may be individually trained. In addition, or alternatively, the plurality of component machine learning models may be at least partially jointly trained. In some examples, the plurality of component machine learning models may be trained using one or more transfer learning techniques to minimize processing resource expenditures by reusing predictive insights learned across the plurality of component models.

In some embodiments, the machine learning ensemble model 416 comprises a plurality of activity specific prediction models and an engagement prediction model. In some examples, each of the plurality of activity specific prediction models and the engagement prediction model may be configured to receive an entity cohort 410 as an input and, responsive to the entity cohort 410, output an engineered parameter value for each of the set of entity data objects of the entity cohort 410. In this manner, the machine learning ensemble model 416 may facilitate the generation of a plurality of individually engineered parameter values for an entity cohort 410 to generate a cohort-level optimization dataset 402.

In some embodiments, the activity specific prediction model is a data entity that describes parameters, hyper-parameters, and/or defined operations of a rules-based and/or machine learning model (e.g., model comprising at least one of one or more rule-based layers, one or more layers that depend on trained parameters, coefficients, and/or the like). An activity specific prediction model may comprise any type of model configured, trained, and/or the like to generate an activity specific score for an entity data object. An activity specific prediction model may comprise one or more of any type of machine learning model comprising one or more supervised, unsupervised, semi-supervised, reinforcement learning models, and/or the like. In some examples, the activity specific prediction model may comprise a supervised machine learning model, such as a neural network, random forest model, naïve bayes classifier, support vector machine, and/or any other machine learning text-based classifier.

In some examples, the activity specific prediction model may be trained using an activity specific labeled training dataset (e.g., one of the labeled training datasets 428). For example, the activity specific prediction model may receive, as an input, a training entity data object and generate, as an output, a training activity specific score. The training activity specific score may be compared to a label of the training entity data object to determine a model loss metric (e.g., an L1 loss, mean absolute error (MAE), L2 loss, mean squared error (MSE)). The activity specific prediction model may be trained, using backpropagation of errors and gradient decent optimization (or other training scheme), to optimize the model loss metric.

In some embodiments, the activity specific labeled training dataset is a data structure that describes a plurality of labeled activity-specific training entries. Each of the plurality of labeled activity-specific training entries, for example, may comprise a training entity data object and a binary label reflective of whether the entity engaged in an activity defined by a predictive parameter in response to a resource. In some examples, an activity specific labeled training dataset may be updated over time based on real world observations. After a threshold number of updates (e.g., 10% increase in dataset size, etc.), the activity specific labeled training dataset may be automatically leveraged to retrain a corresponding activity specific prediction model.

In some embodiments, the engagement prediction model is a data entity that describes parameters, hyper-parameters, and/or defined operations of a rules-based and/or machine learning model (e.g., model comprising at least one of one or more rule-based layers, one or more layers that depend on trained parameters, coefficients, and/or the like). An engagement prediction model may comprise any type of model configured, trained, and/or the like to generate an engagement score for an entity data object. An engagement prediction model may comprise one or more of any type of machine learning model comprising one or more supervised, unsupervised, semi-supervised, reinforcement learning models, and/or the like. In some examples, the engagement prediction model may comprise a machine learning model, such as a neural network, random forest model, naïve bayes classifier, support vector machine, and/or any other machine learning text-based classifier.

In some examples, the engagement prediction model may be trained using a labeled training dataset (e.g., one of the labeled training datasets 428). For example, the engagement prediction model may receive, as an input, an entity data object and generate, as an output, a training engagement prediction model for the entity data object. The training engagement score may be compared to a label of the labeled entity data object to determine a model loss metric (e.g., an L1 loss, mean absolute error (MAE), L2 loss, mean squared error (MSE), etc.). The engagement prediction model may be trained, using backpropagation of errors optimized using gradient descent (or other training scheme), to optimize the model loss metric.

In some embodiments, the labeled training dataset is a data structure that describes a plurality of labeled training entries. The plurality of labeled training entries, for example, May comprise a training entity data object and a binary label reflective of whether the entity engaged with resource (e.g., accepting a clinical house call, etc.). In some examples, a labeled training dataset may be updated over time based on real world observations. After a threshold number of updates (e.g., 10% increase in dataset size), the labeled training dataset may be automatically leveraged to retrain the engagement prediction model.

In some embodiments, the entity-level predictive parameter weights 414 are configurable weighting coefficients that correspond to the predictive parameters. An entity-level predictive parameter weight, for example, may comprise a plurality of learned and/or defined coefficients. For instance, the entity-level predictive parameter weight may be learned based on an observed impact to a threshold improvement for an entity cohort. In some examples, a cohort-level optimization dataset 402 may comprise an entity-level predictive feature weight, WĄ, for each predictive parameter, j.

In some embodiments, a feature-level predictive parameter value 412 is generated based on a comparison between (i) an entity-level predictive parameter value of the one or more entity-level predictive parameter values 404 and (ii) one or more historical entity-level predictive parameter values corresponding to the entity-level predictive parameter value.

In some embodiments, the feature-level predictive feature is a data value that describes a measure trend for a predictive parameter. A feature-level predictive parameter value, for example, may comprise a parameter-level weighting that is measured based on one or more predictive rates of change for a particular predictive parameter. In some examples, a feature-level predictive parameter value may be denoted as IMPR_C and/or IMPR_D. In some examples, the measures IMPR_C and IMPR_D may be denoted as j=M−1 and j=M, respectively.

In some embodiments, a plurality of iterative candidate outputs 422 is generated from the cohort-level optimization dataset 402 using an optimization model 418. The plurality of iterative candidate outputs 422 may respectively correspond to a plurality of constraint set combinations 420. In some examples, the plurality of constraint set combinations 420 may respectively define a plurality of loss functions for the optimization model 418.

In some embodiments, the optimization model 418 is a data entity that describes parameters, hyper-parameters, and/or defined operations of a statistical optimization model.

The optimization model 418 may comprise any type of optimization technique configured, trained, and/or the like to generate an iterative candidate output based on the cohort-level optimization dataset 402. The optimization model 418, for example, may comprise an unsupervised machine learning model, such as a K-means clustering model, principal component analysis (PCA) model, and/or the like.

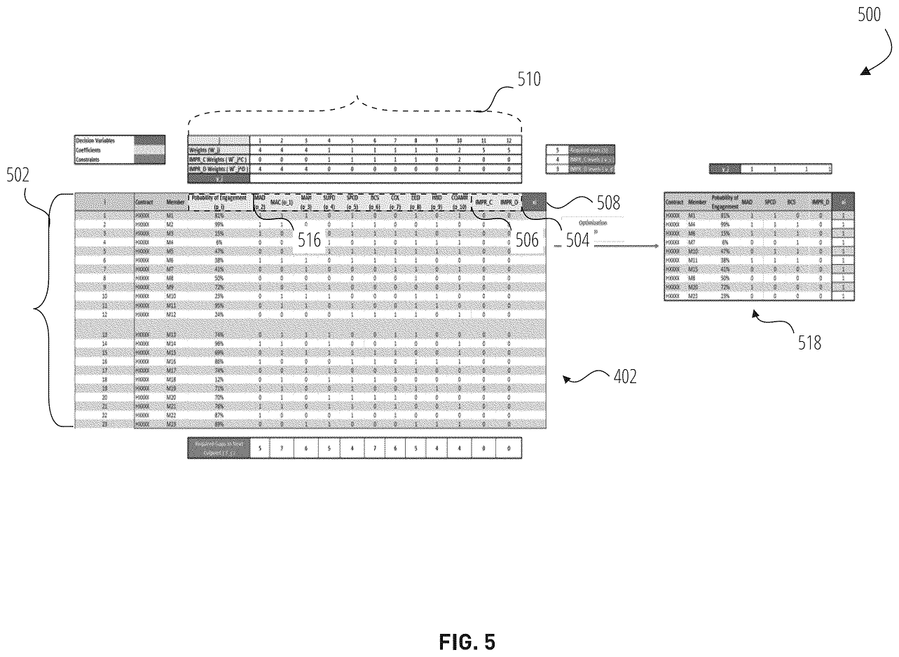

In addition, or alternatively, the optimization model 418 may include an optimization problem solver, such as a branch and bound model, and/or the like. A branch and bound model, for example, may be applied to a 0-1 integer linear programming problem that is modeled by the cohort-level optimization dataset 402 and a set of constraint set combinations 420. For instance, the branch and bound model may be applied to cohort-level optimization dataset 402 to optimize one or more linear objective functions defined by the set of constraint set combinations 420. By way of example, as depicted in FIG. 5, the cohort-level optimization dataset 402 may comprise a set of independent parameters (e.g., entity-level predictive parameter values 404, parameter-level predictive parameter values 412) and one or more dependent parameters (e.g., decision parameters). The optimization model 418 may generate a plurality of dependent parameters to optimize one or more of the constraint set combinations 420 based on the set of independent parameters. In this way, the cohort-level optimization dataset 402 may reduce a complex problem space by the space as an integer linear programming optimization problem in which a set of complex predictions are represented as integer values (e.g., entity-level predictive parameter values 404, parameter-level predictive parameter values 412, decision parameters) that may be used to solve linear, objective functions (e.g., constraint set combinations 420). This, in turn, improves the optimization efficiency for generating predictions within complex prediction spaces that enable the real time generation and modification of target outputs for an entity cohort. By doing so, the optimization model 418, in combination with the cohort-level optimization dataset 402, may facilitate the presentation of complex insight through the user interface 408.

In some embodiments, the constraint set combinations 420 are configurable parameters that respectively define one or more constraints for optimizing an iterative candidate output 422.

In some embodiments, a cutpoint constraint is a first constraint of a constraint set combination. The cutpoint constraint may measure a predicted number of gaps closed by a resource allocation to a subset of entities within entity cohort. For example, the cutpoint constraint may be measured as:

$$for each measure j ∈ \{ 1 , , , , M - 2 \} \text{:} {\sum }_{1}^{N} {p}_{ij} {o}_{ij} {x}_{i} \geq {T}_{j} {y}_{i}$$

where Tⱼ may represent a number of gap closures required for a predictive parameter j to reach its nearest cutpoint.

In some embodiments, a threshold improvement constraint is a second constraint of a constraint set combination. The threshold improvement constraint may solve for a threshold improvement for an entity cohort. For example, the threshold improvement constraint may be measured as:

$${\sum }_{1}^{M} {W}_{j} {y}_{j} \geq S$$

where S represents the number of weighted stars required to achieve a threshold improvement (e.g., a desired contract score).

In some embodiments, a first improvement rate constraint is a third constraint of a constraint set combination. The first improvement rate constraint may solve for a threshold improvement for an entity cohort by taking into account a parameter-level predictive parameter values. For example, the first improvement rate constraint may be measured as:

$${\sum }_{1}^{M - 2} \tilde{{W}_{j}^{c}} {y}_{j} - {v}_{c} {y}_{M - 1} \geq 0$$

where

$$\tilde{{W}_{j}^{c}}$$

represents the IMPR_C parameter-level predictive parameter values of predictive parameter, j.

In some embodiments, a second improvement rate constraint is a fourth constraint of a constraint set combination. The first improvement rate constraint may solve for a threshold improvement for an entity cohort by taking into account a parameter-level predictive parameter values. For example, the first improvement rate constraint may be measured as:

$${\sum }_{1}^{M - 2} \tilde{{W}_{j}^{d}} {y}_{j} - {v}_{d} {y}_{M} \geq 0$$

where

$$\tilde{{W}_{j}^{d}}$$

represents the IMPR_D parameter-level predictive parameter values of predictive where parameter, j.

In some embodiments, the iterative candidate outputs 422 is generated through a plurality of optimization iterations. For example, the plurality of optimization iterations may be performed for the plurality of constraint set combinations 420. For instance, an optimization iteration of the plurality of optimization iterations for a constraint set combination of the plurality of constraint set combinations 420 is performed by generating, using the optimization model 418, a respective iterative candidate output by minimizing an objection function defined by the constraint set combination.

In some embodiments, an optimization iteration is an iteration of an optimization model 418 for a constraint set combination 420. During each optimization iteration, the optimization model 418 may be executed to minimize an objective function in view of a constraint set combination 420. In some examples, four optimization iterations may be performed with different constraint set combinations 420. A first optimization iteration, O_{R1}, for example, may execute with the cutpoint constraint, the threshold improvement constraint, the first improvement rate constraint, and the second improvement rate constraint. A second optimization iteration, O_{R2}, may execute with the cutpoint constraint and the threshold improvement constraint. The third optimization iteration, O_{R3}, may execute with the cutpoint constraint, the threshold improvement constraint, and the first improvement rate constraint. The fourth optimization iteration, O_{R4}, may execute with the cutpoint constraint, the threshold improvement constraint, and the second improvement rate constraint. In this manner, by pregenerating and modelling a plurality of predictive parameter values and the interdependencies therebetween for a plurality of entities within an entity cohort, the cohort-level optimization dataset 402 may enable a plurality of optimization iterations that consider different constraint set combinations in a time efficient manner. By doing so, the cohort-level optimization dataset may be practically applied to improve computer-based optimization approaches by reducing the processing and memory resources traditionally required for use cases with robust and varied predictive measures.

In some examples, the objective function may be defined as:

$$Minimise {\sum }_{1}^{N} {x}_{i} .$$

At each optimization iteration, xᵢ∈{0,1} may be treated as a decision variable representing whether an entity, I(I=1 . . . N) should be allocated a particular resource and yⱼ∈{0,1} may be a binary variable for each predictive parameter (j=1 . . . . M), with yⱼ=1 if the predictive parameter, j, exceeds a cutpoint for the predictive parameter and yⱼ=0 otherwise.

In some examples, the variables of the optimization model may comprise (i) r, which represents a measure rate across all predictive parameter values of an entity cohort, (ii) C, which represents a numeric value identifying a nearest cutpoint value greater than the measure rate r, (iii) Den, a current year denominator, (iv) d:=C−r: distance to nearest cutpoint, (v) T:=d*Den; (vi) W, which represents the entity-level predictive parameter weight for a particular predictive parameter, (vii) \tilde{r}, which represents a prior year parameter value rate, (viii) ρ, a year over year measure correlation, (ix) SE, a prior year standard deviation, and (x) S: =x−r: Distance to nearest improvement level, where x is the root of the following function:

$$\frac{x - \tilde{r}}{\sqrt{\frac{x ( 100 - x )}{{den}_{x}} + {SE}^{2} - 2 ρ SE \sqrt{\frac{x ( 100 - x )}{{Den}_{x}}}}} - 1.96 = 0$$

In some example, \tilde{W}: =(if s≤d then w else 0) and \tilde{W}^{c}: =(if j is a part c parameter value then \tilde{W} else 0.

In some examples, for the parameter-level predictive parameter values, each variable may represent a value for one of the predictive parameters: (i) I_{C}: The IMPR_C rate, C_{c}: The nearest cutpoint for IMPR_C, (ii) w_{c}: The weight of IMPR_C star (usually=5), (ii)

$${q}_{c} := \frac{1}{{\sum }_{j} w} :$$

The value of an improvement level increase within the IMPR_C score, and (iv)

$${v}_{c} := \frac{{I}_{c} - {C}_{c}}{{q}_{c}} :$$

The needed unit weighted improvement level increases to hit the next IMPR_C star.

In some examples, at each optimization iteration, the entity cohort may be processed with respect to a desired improvement level increase, which may be defined as the difference between: R:a current score and D:a desired score for the entity cohort. The value of a unit measure increase for an entity cohort where i represents and eligible star measure may be denoted as:

$$u := \frac{1}{{\sum }_{i} w} .$$

The needed unit weighted star increases required to hit the desired score may be denoted as:

$$S := \frac{( D - R )}{u} .$$

In some embodiments, a target output 424 is selected from the plurality of iterative candidate outputs 422 based on selection criteria. In some examples, the target output 424 identifies a subset of entity data objects from the plurality of entity data objects and a subset of entity-level predictive parameter values from the plurality of entity-level predictive parameter values 404. In some examples, the user interface 408 may be modified to identify the subset of entity data objects from the set of entity data objects in response to the resource allocation request 406.

In some embodiments, an iterative candidate output 422 is an output of an optimization iteration. An iterative candidate output, for example, may comprise a subset of entity data objects and a subset of entity-level predictive parameter values from the cohort-level optimization dataset 402 that minimize the objective function in view of the constraint set combination 420 of a particular optimization iteration. In some examples, a target output 424 may be selected from a plurality of iterative candidate outputs 422 based on selection criteria.

In some embodiments, the subset of entity data objects is a portion of an iterative candidate output. The subset of entity data objects, for example, may identify a subset of entity data objects from a cohort-level optimization dataset 402 that may achieve an optimal outcome if allocated a resource.

In some embodiments, the subset of entity-level predictive parameter values 404 is another portion of an iterative candidate output 422. The subset of the entity-level predictive parameter values 404, for example, may identify a subset of the entity-level predictive parameter values 404 from a cohort-level optimization dataset 402 that may achieve an optimal outcome if processed during an allocated resource. In a healthcare domain, for example, a subset of the entity-level predictive parameter values 404 may identify one or more clinical activities that may have an optimal impact if performed during a clinical visit allocated to an entity.

In some embodiments, the selection criteria is a configurable parameter that defines one or more rules for selecting the target output 424 from a plurality of iterative candidate outputs 422. The selection criteria, for example, may constrain the selection of the target output 424 to an iterative candidate output with the minimum number of entity data objects within a subset of entity data objects. For example, given optimized objectives for each run O_{R1}, O_{R2}, O_{R3}, O_{R4} a target output 424 (e.g., where xᵢ=1 & yᵢ) may be selected that corresponds to min (O_{R1}, O_{R2}, O_{R3}, O_{R4}).

In some embodiments, each of the subset of the entity-level predictive parameter values 404 is associated with a prediction-based action. In some examples, one or more prediction-based actions associated with the subset of the entity-level predictive parameter values 404 may be initiated using the user interface 408. A prediction-based action, for example, may comprise administering a diabetes medication.

In some embodiments, a prediction-based action is a computing and/or physical action performed in response to an iterative candidate output. A prediction-based action is domain specific and may comprise any physical or virtual action. In some examples, a prediction-based action may comprise one or more user interface actions, one or more engagement actions, and/or one or more activity-specific actions. For instance, the one or more user interface actions may comprise an augmentation of a user interface to present one or more portions of a target output 424. For example, a target output 424 may be presented through one or more interactive screens of the user interface 408.

In some examples, the one or more engagement actions may comprise one or more communication actions between a computing entity, such as a user device displaying the user interface 408, and an entity of the subset of entity data objects. In some examples, an engagement action may be performed in response to a selection of an interactive entity icon from the user interface. The engagement action may comprise an electronic mail (email), an automated voice call, a text message, and/or any other type of communication channel for requesting an entity's engagement with a resource.

The one or more activity-specific actions may correspond to activity-based predictive parameter values for a particular prediction domain. For instance, in a healthcare domain, the one or more activity-specific actions may comprise actions that correspond to quality measures for a healthcare rating system, such as the Medicare STARS program. By way of example, the activity-specific actions may comprise (i) continuous actions, such as medication adherence actions in which a medication may be automatically administered via one or more instructions from a computing system, (ii) single actions, such as screening operations (e.g., breast cancer screening, etc.) automatically performed responsive to one or more instructions from a computing system, and/or (iii) monitoring actions, such as blood pressure and glucose tests that may be automatically performed responsive to one or more instructions from a computing system. As one example, a prediction-based action may comprise the administration of a medication, such as a diabetes medication (e.g., Medformin, Meglitinide, etc.), that is controlled, via instructions from a computing system, in response to a predictive parameter values from the subset of the entity-level predictive parameter values 404 indicating a medication adherence requirement.

Other examples of activity-specific actions for other use cases may comprise (i) transmitting one or more control instructions to one or more security mechanisms (e.g., alarm systems, door locks, etc.) within the surveilled environment to trigger an alarm, lock a door, and/or the like, transmitting one or more control instruction to one or more connected computers to trigger an execution of a computing task, and/or the like.

In some embodiments, a resource allocation response 426 is received from a user device (e.g., via the user interface 408). The resource allocation response 426 may identify an observed outcome associated with the target output 424. In some examples, one or more of the labeled training datasets 428 may be modified based on the resource allocation request 406 and the target output 424. In some examples, at least a portion of the machine learning ensemble model 416 may be trained based on the labeled training datasets 428.

In some embodiments, the resource allocation response 426 is a data message that describes a response to one or more prediction-based actions. A resource allocation response 426, for example, may identify one or more observed outcomes for each of the subset of entity data objects identified in a target output. In some embodiments, the observed outcomes may comprise ground truths for a machine learning model based on an observed real-world event. An observed outcome, for example, may identify an engagement of an entity in response to an allocation of a resource to the entity. For example, in a healthcare domain, an observed outcome may identify whether an entity engaged with a healthcare provider after offering a clinical visit. In addition, or alternatively, an observed outcome may identify one or more prediction-based actions performed for an entity. For example, in a healthcare domain, an observed outcome may describe the results of a blood glucose test, the administration of a diabetes medication, a screening operation, and/or the like. Other examples of observed outcomes for a computer domain may comprise the performance metrics of a computer responsive to an execution of a subset of entity data objects. In some examples, observed outcomes may be recorded and leveraged to augment one or more labeled training datasets 428 for continuously training the models of the present disclosure.

In this manner, through an iterative, training feedback loop may be formed to iteratively optimize an optimization model 418 and machine learning ensemble model 416 for an optimization task. This, in turn, may improve optimization iterations by improving creation, storage, and processing of a cohort-level optimization dataset 402. By doing so, an improved cohort-level optimization dataset 402 may be adaptively generated to improve computer functionality with respect the optimization-based predictions. An example of a cohort-level optimization dataset 402 may be discussed in further detail with reference to FIG. 5.

FIG. 5 depicts an operational example 500 of a cohort-level optimization dataset 402 in accordance with some embodiments of the present disclosure. The operational example 500 shows a plurality of entities 502 from an entity cohort, which are indexed by entity cohort identifiers. For each entity, the cohort-level optimization dataset 402 may comprise a set of independent, predictive parameters and one or more dependent parameters that may be toggled (e.g., using the optimization model) to optimize one or more constraint set combinations in view of the set of independent parameters. By way of example, the set of independent parameters may comprise one or more parameter-level predictive parameters 504, one or more of activity specific entity-level predictive parameters 506, and/or an engagement specific entity-level predictive parameter 516. The one or more dependent parameters may include the decision parameter 508 that may be modified, during one or more optimization iterations, to generate an iterative candidate output 518. In some examples, the cohort-level optimization dataset 402 may further include one or more entity-level predictive parameter weights 510 to model relationships between one or more of the set of independent parameters.

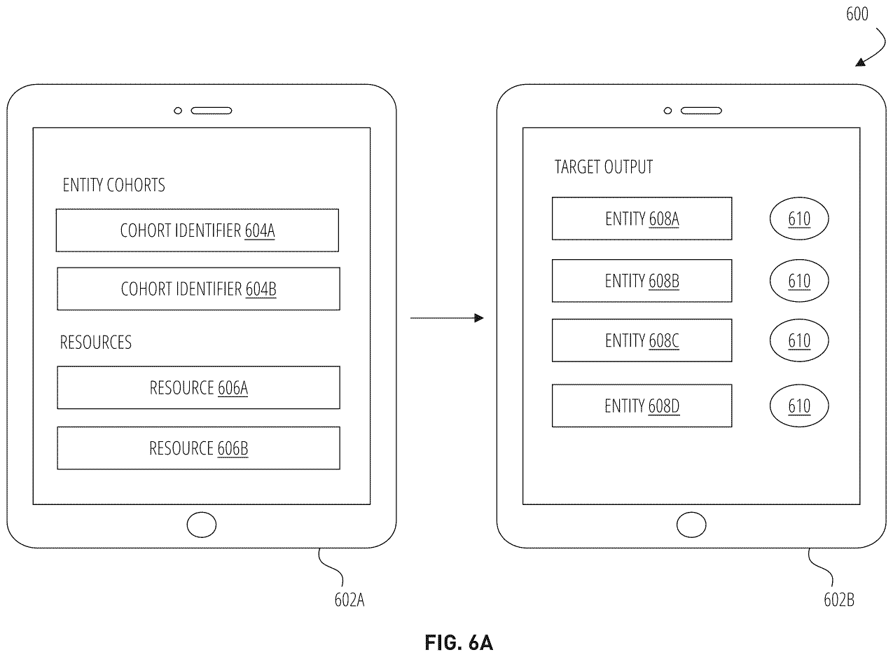

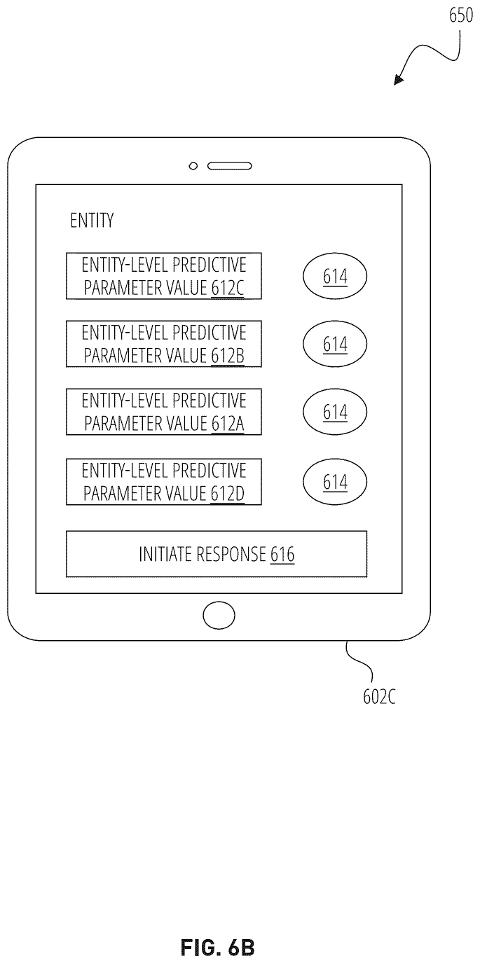

As described herein, a target output may be selected from a plurality of iterative candidate outputs to initiate one or more prediction-based actions. The prediction-based actions may comprise user interface actions for modifying and/or navigating a plurality of user interface screens of a user interface. One or more example screens are described in further detail with reference to FIGS. 6A-C.

FIGS. 6A-B depict operational examples user interface screens for initiating one or more prediction-based actions of the present disclosure. FIG. 6A, for example, shows a first operational example 600 of a first interface screen 602A and a second interface screen 602B. FIG. 6B shows a second operational example 650 of a third interface screen 602C.

The first interface screen 602A may comprise a plurality icons associated with cohort identifiers 604A-B that each identify an entity cohort. In some examples, the icons may comprise interactive icons that may initiate a resource allocation request for an entity cohort responsive to user input. In addition, or alternatively, the first interface screen 602A may comprise a plurality icons associated with resources 606A-B that each identify a resource for allocation to an entity cohort. In some examples, the icons may comprise interactive icons that may initiate a resource allocation request for a resource responsive to user input.

The second interface screen 602B may comprise a plurality icons associated with entity identifiers that each identify an entity from an entity cohort selected for a resource allocation request. For example, the first interface screen 602A may present an entity cohort with one or more interactive request icons for initiating the resource allocation request. Responsive to the selection of an interactive request icon, the first interface screen 602A may be modified to generate a second interface screen 602B that presents a subset of entity data object icons 608A-D. In some examples, each of the subset of entity data objects icons 608A-D may be presented with one or more interactive entity icons 610. Upon selection of an interactive entity icon 610, the second interface screen 602B may be modified to generate a third interface screen 602C. In some examples, the third interface screen 602C presents a subset of entity-level predictive parameter value icons 612A-D for a selected entity. Each of the subset of entity-level predictive parameter value icons 612A-D may be presented with one or more interactive entity icons 614. In some examples, one or more of the icons 614 may be selected and, once selected, an initiate response icon 616 may be selected to initiate one or more prediction-based actions. In some examples, an engagement action and/or activity specific action may be performed in response to a selection of an interactive entity icon from the user interface. In this manner, one or more prediction-based actions may be performed to provide an improved user interface for automatically displaying icons to a user based on optimization operations for an entity cohort.

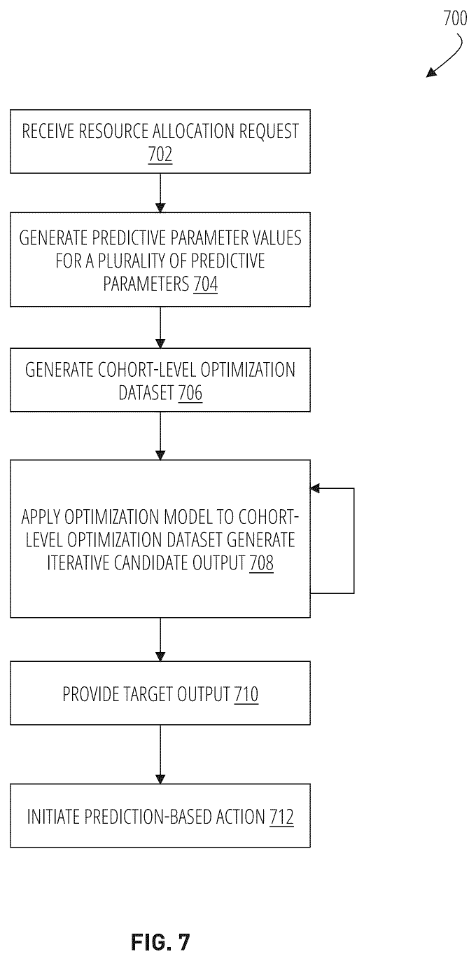

FIG. 7 depicts a flowchart diagram of an example process 700 for optimizing target output in accordance with some embodiments of the present disclosure. The flowchart depicts an optimization and iterative training technique that leverages a machine learning ensemble to extract predictive parameters for an optimization technique. The process 700 may be implemented by one or more computing devices, entities, and/or systems described herein. For example, via the various steps/operations of the process 700, the computing system 101 may leverage improved cohort-level optimization datasets and optimized models tailored thereto to interpret and extract target outputs from a robust dataset. By doing so, the process 700 enables the actionable insights for allocating finites resources across a population of entities to optimize computing performance with respect to various predictive tasks.

FIG. 7 illustrates an example process 700 for explanatory purposes. Although the example process 700 depicts a particular sequence of steps/operations, the sequence may be altered without departing from the scope of the present disclosure. For example, some of the steps/operations depicted may be performed in parallel or in a different sequence that does not materially impact the function of the process 700. In other examples, different components of an example device or system that implements the process 700 may perform functions at substantially the same time or in a specific sequence.

In some embodiments, the process 700 comprises, at operation 702, receiving a resource allocation request. For example, the computing system 101 may receive, via a user interface accessible to a user device, a resource allocation request that comprises a cohort identifier. The computing system 101 may identify a plurality of entity data objects based on the cohort identifier.

In some embodiments, the process 700 comprises, at operation 704, generating predictive parameter values for a plurality of predictive parameters. For example, the computing system 101 may generate, using a machine learning ensemble model, an entity-level predictive parameter value for an entity data object of the set of entity data object based on an entity attribute of the entity data object. In addition, or alternatively, the computing system 101 may generate a parameter-level predictive parameter value based on a comparison between (i) the entity-level predictive parameter value and (ii) one or more historical entity-level predictive parameter values corresponding to the entity-level predictive parameter value. In some examples, the machine learning ensemble model may comprise an engagement prediction model and a plurality of activity-specific prediction models. In some examples, each of the plurality of activity-specific prediction models is trained, using one or more supervisory training techniques, based on an activity-specific labeled training dataset of the plurality of activity-specific prediction models.

In some embodiments, the process 700 comprises, at operation 706, generating a cohort-level optimization dataset. For example, the computing system 101 may generate a cohort-level optimization dataset that comprises an entity-level predictive parameter value and a feature-level predictive parameter values for the set of entity data objects. In some examples, the cohort-level optimization dataset further comprises an entity-level predictive parameter value weights.

In some embodiments, the process 700 comprises, at operation 708, applying an optimization model to the cohort-level optimization dataset to generate an iterative candidate output. For example, the computing system 101 may apply the optimization model to the cohort-level optimization dataset to generate an iterative candidate output for a constraint set combination. In some examples, the computing system 101 may perform a plurality of optimization iterations respectively for a plurality of constraint set combinations. For instance, a constraint set combination may define a linear object loss function for optimizing a dependent parameter of the cohort-level optimization dataset. The computing system 101 may perform each optimization iteration of the plurality of optimization iterations for a constraint set combination of the plurality of constraint set combinations by generating, using the optimization model, a respective iterative candidate output by minimizing the linear objective loss function defined by a constraint set combination. By way of example, the plurality of constraint set combinations may respectively define a plurality of linear loss functions of a 0-1 integer linear programming problem.

In some embodiments, the process 700 comprises, at operation 710, providing a target output. For example, the computing system 101 may select and then provide a target output from the plurality of iterative candidate outputs based on the selection criteria. The target output, for example, may identify a subset of entity data objects from the set of entity data objects and a subset of entity-level predictive parameter values from the plurality of entity-level predictive parameter values.

In some embodiments, the process 700 comprises, at operation 712, initiating prediction-based action. For example, the computing system 101 may, responsive to the resource allocation request, modify the user interface to identify the subset of entity data objects from the set of entity data objects. In some examples, each of the subset of entity data objects may be associated with one or more entity-level predictive parameter values that are respectively associated with a prediction-based action. The computing system 101 may initiate, using the user interface, one or more prediction-based actions associated to the subset of entity-level predictive features. By way of example, a prediction-based action may comprise administering a diabetes medication. The computing system 101 may perform various other actions with respect to one or more of the plurality of entities identified by a target output.

For instance, some techniques of the present disclosure enable the generation of action outputs that may be performed to initiate one or more real world actions to achieve real-world effects. The techniques of the present disclosure may be used, applied, and/or otherwise leveraged to identify entities for allocation of a finite resource, such as processing resources, memory, time, and/or the like. For instance, the action outputs may comprise automated clinical actions that may trigger the performance of actions at a client device, such as the display, transmission, and/or the like of data reflective of clinical parameters (e.g., continuous actions, such as medication adherence actions, etc., single actions, such as screening operations, etc., monitoring actions, such as blood pressure and glucose tests, etc.). In some embodiments, parameters may trigger an alert, and/or the like. The alert may be automatically communicated to a user and/or be used to initiate a security protocol (e.g., locking a computer, etc.), a robotic action (e.g., performing an automated screening process, etc.), and/or the like.

In some examples, the computing tasks may comprise actions that may be based on a prediction domain. A prediction domain may comprise any environment in which computing systems may be applied to interpret, store, and process data and initiate the performance of computing tasks responsive to the data. These actions may cause real-world changes, for example, by controlling a hardware component, providing alerts, interactive actions, and/or the like. For instance, actions may comprise the initiation of automated instructions across and between devices, automated notifications, automated scheduling operations, automated precautionary actions, automated security actions, automated data processing actions, and/or the like.

In some embodiments, the process 700 comprises receiving, from a user device, a resource allocation response that identifies an observed outcome associated with the target output. For example, the computing system 101 may receive, from a user device, a resource allocation response that identifies an observed outcome associated with the target output. The computing system 101 may modify a labeled training dataset based on the resource allocation request and the target output and train a portion of the machine learning ensemble model based on the labeled training dataset. In some examples, the computing system 101 may train the engagement prediction model using the labeled training dataset.

### VI. Conclusion

Throughout this specification, components, operations, or structures described as a single instance may be implemented as multiple instances. Although individual operations of one or more methods (or processes, techniques, routines, etc.) are illustrated and described as separate operations, two or more of the individual operations may be performed concurrently or otherwise in parallel, and nothing requires that the operations be performed in the order illustrated. Structures and functionality (e.g., operations, steps, blocks) presented as separate components in example configurations may be implemented as a combined structure, functionality, or component. Similarly, structures and functionality presented as a single component may be implemented as separate components. These and other variations, modifications, additions, and improvements fall within the scope of the subject matter herein.

Certain embodiments are described herein as comprising logic or a number of routines, subroutines, applications, operations, blocks, or instructions. These may constitute and/or be implemented by software (e.g., code embodied on a non-transitory, machine-readable medium), hardware, or a combination thereof. In hardware, the routines, etc., may represent tangible units capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware component that operates to perform certain operations as described herein.

In various embodiments, a hardware component may be implemented mechanically or electronically. For example, a hardware component may comprise dedicated circuitry or logic that is permanently configured (e.g., as a special-purpose processor, such as a field programmable gate array (FPGA) or an application-specific integrated circuit (ASIC)) to perform certain operations. A hardware component may also or instead comprise programmable logic or circuitry (e.g., as encompassed within one or more general-purpose processors and/or other programmable processor(s)) that is temporarily configured by software to perform certain operations.

Accordingly, the term “hardware component” should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware components are temporarily configured (e.g., programmed), each of the hardware components need not be configured or instantiated at any one instance in time. For example, where the hardware components comprise a general-purpose processor configured using software, the general-purpose processor may be configured as respective different hardware components at different times. Software may accordingly configure a processor, for example, to constitute a particular hardware component at one instance of time and to constitute a different hardware component at a different instance of time.

Hardware components can provide information to, and receive information from, other hardware components. Accordingly, the described hardware components may be regarded as being communicatively coupled. Where multiple of such hardware components exist contemporaneously, communications may be achieved through signal transmission (e.g., over appropriate circuits and buses) that connect the hardware components. In embodiments in which multiple hardware components are configured or instantiated at different times, communications between such hardware components may be achieved, for example, through the storage and retrieval of information in memory structures to which the multiple hardware components have access. For example, one hardware component may perform an operation and store the output of that operation in a memory device to which it is communicatively coupled. A further hardware component may then, at a later time, access the memory device to retrieve and process the stored output. Hardware components may also initiate communications with input or output devices, and can operate on a resource (e.g., a collection of information).

As noted above, the various operations of example methods (or processes, techniques, routines, etc.) described herein may be performed, at least partially, by one or more processors that are temporarily configured (e.g., by software) or permanently configured to perform the relevant operations. Whether temporarily or permanently configured, such processors may constitute processor-implemented components that operate to perform one or more operations or functions. The components referred to herein may, in some example embodiments, comprise processor-implemented components.

Moreover, each operation of processes illustrated as logical flow graphs may represent a sequence of operations that can be implemented in hardware, software, or a combination thereof. In the context of software, the operations represent computer-executable instructions stored on one or more computer-readable storage media that, when executed by one or more processors, perform the recited operations. Generally, computer-executable instructions comprise routines, programs, objects, components, data structures, and the like that perform particular functions or implement particular data types. The order in which the operations are described is not intended to be construed as a limitation, and any number of the described operations can be combined in any order and/or in parallel to implement the processes.

The terms “coupled” and “connected,” along with their derivatives, may be used. In particular embodiments, “connected” may be used to indicate that two or more elements are in direct physical or electrical contact with each other, although the context in the description may dictate otherwise when it is apparent that two or more elements are not in direct physical or electrical contact. “Coupled” may mean that two or more elements are in direct physical or electrical contact. However, “coupled” may also mean that two or more elements are not in direct contact with each other, yet still co-operate, transmit between, or interact with each other.

An algorithm may be considered to be a self-consistent sequence of acts or operations leading to a desired result. These comprise physical manipulations of physical quantities. Usually, though not necessarily, these quantities take the form of electrical, magnetic, or optical signals capable of being stored, transferred, combined, compared, and otherwise manipulated. These signals are commonly referred to as bits, values, elements, symbols, characters, terms, numbers, flags, or the like. It should be understood, however, that all of these and similar terms are to be associated with the appropriate physical quantities and are merely convenient labels applied to these quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “some embodiments,” “one embodiment,” “an embodiment,” “in some examples,” or variations thereof means that a particular element, feature, structure, characteristic, operation, or the like described in connection with the embodiment is comprised in at least one embodiment, but not every embodiment necessarily comprises the particular element, feature, structure, characteristic, operation, or the like. Different instances of such a reference in various places in the specification do not necessarily all refer to the same embodiment, although they may in some cases. Moreover, different instances of such a reference may describe elements, features, structures, characteristics, operations, or the like be combined in any manner as an embodiment.

As used herein, the terms “comprises,” “comprising,” “comprises,” “comprising,” “has,” “having” or any other variation thereof, are intended to cover a non-exclusive inclusion. For example, a process, method, article, or apparatus that comprises a list of elements is not necessarily limited to only those elements but may comprise other elements not expressly listed or inherent to such process, method, article, or apparatus. Further, unless the context of use clearly indicates otherwise, “or” refers to an inclusive or and not to an exclusive or. For example, a condition A or B is satisfied by any one of the following: A is true (or present) and B is false (or not present), A is false (or not present) and B is true (or present), and both A and B are true (or present).

The term “set” is intended to mean a collection of elements and can be a null set (i.e., a set containing zero elements) or may comprise one, two, or more elements. A “subset” is intended to mean a collection of elements that are all elements of a set, but that does not comprise other elements of the set. A first subset of a set may comprise zero, one, or more elements that are also elements of a second subset of the set. The first subset may be said to be a subset of the second subset if all the elements of the first subset are elements of the second subset, while also being a subset of the set. However, if all the elements of the second subset are also elements of the first subset (in addition to all the elements of the first subset being elements of the second subset), the first subset and the second subset are a single subset/not distinct.

For the purposes of the present disclosure, the term “a” or “an” entity refers to one or more of that entity. As such, the terms “a” or “an”, “one or more”, and “at least one” can be used interchangeably herein unless explicitly contradicted by the specification using the word “only one” or similar. For example, “a first element” may functionally be interpreted as “a first one or more elements” or a “first at least one element.” Unless otherwise apparent from the context of use, reference in the present disclosure to a same set of “one or more processors” (or a same “plurality of processors,” etc.) performing multiple operations can encompass implementations in which performance of the operations is divided among the processor(s) in any suitable way. For example, “generating, by one or more processors, X; and generating, by the one or more processors, Y” can encompass: (1) implementations in which a first subset of the processors (e.g., in a first computing device) generates X and an entirely distinct, second subset of the processors (e.g., in a different, second computing device) independently generates Y; (2) implementations in which one or more or all of the processor(s) (e.g., one or multiple processors in the same device, or multiple processors distributed among multiple devices) contribute to the generation of X and/or Y; and (3) other variations. This may similarly be applied to any other component or feature similarly recited (e.g., as “a component”, “a feature”, “one or more components”, “one or more features”, “a plurality of components”, “a plurality of features”). Moreover, the performance of certain of the operations may be distributed among the one or more components, not only residing within a single machine, but deployed across a number of machines. The set of components may be located in a single geographic location (e.g., within a home environment, an office environment, a cloud environment). In other example embodiments, the set of components may be distributed across two or more geographic locations. Further, “a machine-learned model”, equivalent terms (e.g., “machine learning model,” “machine-learning model,” “machine-learned component”, “artificial intelligence”, “artificial intelligence component”), or species thereof (e.g., “a large language model”, “a neural network”) may comprise a single machine-learned model or multiple machine-learned models, such as a pipeline comprising two or more machine-learned models arranged in series and/or parallel, an agentic framework of machine-learned models, or the like.

An “artificial intelligence” or “artificial intelligence component” may comprise a machine-learned model. A machine-learned model may comprise a hardware and/or software architecture having structural hyperparameters defining the model's architecture and/or one or more parameters (e.g., coefficient(s), weight(s), biase(s), activation function(s) and/or action function type(s) in examples where the activation function and/or function type is determined as part of training, clustering centroid(s)/medoid(s), partition(s), number of trees, tree depth, split parameters) determined as a result of training the machine-learned model based at least in part on training hyperparameters (e.g., for supervised, semi-supervised, and reinforcement learning models) and/or by iteratively operating the machine-learned model according to the training hyperparameters (e.g., for unsupervised machine-learned models).

In some examples, structural hyperparameter(s) may define component(s) of the model's architecture and/or their configuration/order, such as, for example, the configuration/order specifying which input(s) are provided to one component and which output(s) of that component are provided as input to other component(s) of the machine-learned model; a number, type, and/or configuration of component(s) per layer; a number of layers of the model; a number and/or type of input nodes in an input layer of the model; a number and/or type of nodes in a layer; a number and/or type of output nodes of an output layer of the model; component dimension (e.g., input size versus output size); a number of trees; a maximum tree depth; node split parameters; minimum number of samples in a leaf node of a tree; and/or the like. The component(s) of the model may comprise one or more activation functions and/or activation function type(s) (e.g., gated linear unit (GLU), such as a rectified linear unit (ReLU), leaky RELU, Gaussian error linear unit (GELU), Swish, hyperbolic tangent), one or more attention mechanism and/or attention mechanism types (e.g., self-attention, cross-attention), nodes and split indications and/or probabilities in a decision tree, and/or various other component(s) (e.g., adding and/or normalization layer, pooling layer, filter). Various combinations of any these components (as defined by the structural hyperparameter(s)) may result in different types of model architectures, such as a transformer-based machine-learned model (e.g., encoder-only model(s), encoder-decoder model(s), decoder-only models, generative pre-trained transformer(s) (GPT(s))), neural network(s), multi-layer perceptron(s), Kolmogorov-Arnold network(s), clustering algorithm(s), support vector machine(s), gradient boosting machine(s), and/or the like. The structural parameters and components a machine-learned model comprises may vary depending on the type of machine-learned model.

Training hyperparameter(s) may be used as part of training or otherwise determining the machine-learned model. In some examples, the training hyperparameter(s), in addition to the training data and/or input data, may affect determining the parameter(s) of the target machine-learned model. Using a different set of training hyperparameters to train two machine-learned models that have the same architecture (i.e., the same structural hyperparameters) and using the same training data may result in the parameters of the first machine-learned model differing from the parameters of the second machine-learned model. Despite having the same architecture and having been trained using the same training data, such machine-learned models may generate different outputs from each other, given the same input data. Accordingly, accuracy, precision, recall, and/or bias may vary between such machine-learned models.

In some examples, training hyperparameter(s) may comprise a train-test split ratio, activation function and/or activation function type (e.g., in examples like Kolmogorov-Arnold networks (KANs) where the activation function type is determined as part of training from an available set of activation functions and/or limits on the activation function parameters specified by the training hyperparameters), training stage(s) (e.g., using a first set of hyperparameters for a first epoch of training, a second set of hyperparameters for a second epoch of training), a batch size and/or number of batches of data in a training epoch, a number of epochs of training, the loss function used (e.g., L1, L2, Huber, Cauchy, cross entropy), the component(s) of the machine-learned model that are altered using the loss for a particular batch or during a particular epoch of training (e.g., some components may be “frozen,” meaning their parameters are not altered based on the loss), learning rate, learning rate optimization algorithm type (e.g., gradient descent, adaptive, stochastic) used to determine an alteration to one or more parameters of one or more components of the machine-learned model to reduce the loss determined by the loss function, learning rate scheduling, and/or the like.

In some examples, the structural hyperparameters and/or the training hyperparameters may be determined by a hyperparameter optimization algorithm or based on user input, such as a software component written by a user or generated by a machine-learned model. The machine-learned model may comprise any type of model configured, trained, and/or the like to generate a prediction output for a model input. In some examples, any of the logic, component(s), routines, and/or the like discussed herein may be implemented as a machine-learned model.

The machine-learned model may comprise one or more of any type of machine-learned model comprising one or more supervised, unsupervised, semi-supervised, and/or reinforcement learning models. Training a machine-learned model may comprise altering one or more parameters of the machine-learned model (e.g., using a loss optimization algorithm) to reduce a loss. Depending on whether the machine-learned model is supervised, semi-supervised, unsupervised, etc. this loss may be determined based at least in part on a difference between an output generated by the model and ground truth data (e.g., a label, an indication of an outcome that resulted from a system using the output), a cost function, a fit of the parameter(s) to a set of data, a fit of an output to a set of data, and/or the like. In some examples, determining an output by a machine-learned model may comprise executing a set of inference operations executed by the machine-learned model according to the target machine-learned model's parameter(s) and structural hyperparameter(s) and using/operating on a set of input data.

Moreover, any discussion of receiving data associated with an individual that may be protected, confidential, or otherwise sensitive information, is understood to have been preceded by transmitting a notice of use of the data to a computing device, account, or other identifier (collectively, “identifier”) associated with the individual, receiving an indication of authorization to use the data from the identifier, and/or providing a mechanism by which a user may cause use of the data to cease or a copy of the data to be provided to the user.

Upon reading this disclosure, those of skill in the art will appreciate still additional alternative structural and functional designs through the principles disclosed herein. Therefore, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

The patent claims at the end of this patent application are not intended to be construed under 35 U.S.C. § 112 (f) unless traditional means-plus-function language is expressly recited, such as “means for” or “step for” language being explicitly recited in the claim(s).

### VII. Examples

Some embodiments of the present disclosure may be implemented by one or more computing devices, entities, and/or systems described herein to perform one or more example operations, such as those outlined below. The examples are provided for explanatory purposes. Although the examples outline a particular sequence of steps/operations, each sequence may be altered without departing from the scope of the present disclosure. For example, some of the steps/operations may be performed in parallel or in a different sequence that does not materially impact the function of the various examples. In other examples, different components of an example device or system that implements a particular example may perform functions at substantially the same time or in a specific sequence.

Moreover, although the examples may outline a system or computing entity with respect to one or more steps/operations, each operation may be performed by any one or combination of computing devices, entities, and/or systems described herein. For example, a computing system may comprise a single computing entity that is configured to perform all of the steps/operations of a particular example. In addition, or alternatively, a computing system may comprise multiple dedicated computing entities that are respectively configured to perform one or more of the steps/operations of a particular example. By way of example, the multiple dedicated computing entities may coordinate to perform all of the steps/operations of a particular example.

Example 1. A computer-implemented method comprising generating, by one or more processors, a cohort-level optimization dataset that comprises an entity-level predictive parameter value and a parameter-level predictive parameter value for an entity data object of a set of entity data objects by generating, using a machine learning ensemble model, the entity-level predictive parameter value for the entity data object based on an entity attribute of the entity data object, and generating the parameter-level predictive parameter value based on a comparison between (i) the entity-level predictive parameter value and (ii) one or more historical entity-level predictive parameter values corresponding to the entity-level predictive parameter value; applying, by the one or more processors, an optimization model to the cohort-level optimization dataset to generate an iterative candidate output for a constraint set combination; and providing, by the one or more processors, a target output based on a comparison between the iterative candidate output and one or more second iterative candidate outputs respectively corresponding to one or more second constraint set combinations.

Example 2. The computer-implemented method of example 1, wherein the target output identifies a subset of entity data objects from the set of entity data objects and a subset of entity-level predictive parameter values from a set of entity-level predictive parameter values of the cohort-level optimization dataset.

Example 3. The computer-implemented method of example 2, wherein the computer-implemented method further comprises receiving, via a user interface accessible to a user device, a resource allocation request comprising a cohort identifier; identifying the set of entity data objects based on the cohort identifier; and responsive to the resource allocation request, modifying the user interface to identify the subset of entity data objects from the set of entity data objects.

Example 4. The computer-implemented method of example 3, wherein each of the subset of entity-level predictive features is associated with a prediction-based action and the computer-implemented method further comprises initiating, using the user interface, a prediction-based actions associated with one of the subset of entity-level predictive features.

Example 5. The computer-implemented method of example 4, wherein the prediction-based action comprises administering a diabetes medication.

Example 6. The computer-implemented method of any of the preceding examples, further comprising receiving, from a user device, a resource allocation response that identifies an observed outcome associated with the target output; modifying a labeled training dataset based on the resource allocation response and the target output; and training a portion of the machine learning ensemble model based on the labeled training dataset.

Example 7. The computer-implemented method of example 6, wherein the machine learning ensemble model comprises an engagement prediction model and a plurality of activity-specific prediction models and the engagement prediction model is trained using the labeled training dataset.

Example 8. The computer-implemented method of example 7, wherein each of the plurality of activity-specific prediction models is trained, using one or more supervisory training techniques, based on an activity-specific labeled training dataset of the plurality of activity-specific prediction models.

Example 9. The computer-implemented method of any of the preceding examples, wherein the cohort-level optimization dataset further comprises an entity-level predictive parameter weight.

Example 10. The computer-implemented method of any of the preceding examples, wherein the cohort-level optimization dataset comprises a dependent parameter corresponding to the entity-level predictive parameter value and the parameter-level predictive parameter value and the constraint set combination defines a linear objective loss function for optimizing the dependent parameter.

Example 11. The computer-implemented method of any of the preceding examples, wherein determining the iterative candidate output from the cohort-level optimization dataset comprises performing an optimization iteration for the constraint set combination by minimizing a linear objective loss function defined by the constraint set combination.

Example 12. A system comprising one or more processors; and one or more memories storing processor-executable instructions that, when executed by the one or more processors, cause the one or more processors to perform operations comprising generating a cohort-level optimization dataset that comprises an entity-level predictive parameter value and a parameter-level predictive parameter value for an entity data object of a set of entity data objects by generating, using a machine learning ensemble model, the entity-level predictive parameter value for the entity data object based on an entity attribute of the entity data object, and generating the parameter-level predictive parameter value based on a comparison between (i) the entity-level predictive parameter value and (ii) one or more historical entity-level predictive parameter values corresponding to the entity-level predictive parameter value; applying an optimization model to the cohort-level optimization dataset to generate an iterative candidate output for a constraint set combination; and providing a target output based on a comparison between the iterative candidate output and one or more second iterative candidate outputs respectively corresponding to one or more second constraint set combinations.

Example 13. The system of example 12, wherein the target output identifies a subset of entity data objects from the set of entity data objects and a subset of entity-level predictive parameter values from a set of entity-level predictive parameter values of the cohort-level optimization dataset.

Example 14. The system of example 13, wherein the one or more operations further comprise receiving, via a user interface accessible to a user device, a resource allocation request comprising a cohort identifier; identifying the set of entity data objects based on the cohort identifier; and responsive to the resource allocation request, modifying the user interface to identify the subset of entity data objects from the set of entity data objects.

Example 15. The system of example 14, wherein each of the subset of entity-level predictive features is associated with a prediction-based action and the computer-implemented method further comprises initiating, using the user interface, a prediction-based actions associated with one of the subset of entity-level predictive features.

Example 16. The system of example 15, wherein the prediction-based action comprises administering a diabetes medication.

Example 17. The system of any of examples 12 through 16, wherein the one or more operations further comprise receiving, from a user device, a resource allocation response that identifies an observed outcome associated with the target output; modifying a labeled training dataset based on the resource allocation response and the target output; and training a portion of the machine learning ensemble model based on the labeled training dataset.

Example 18. One or more non-transitory computer-readable media storing processor-executable instructions that, when executed by one or more processors, cause the one or more processors to perform operations comprising generating a cohort-level optimization dataset that comprises an entity-level predictive parameter value and a parameter-level predictive parameter value for an entity data object of a set of entity data objects by generating, using a machine learning ensemble model, the entity-level predictive parameter value for the entity data object based on an entity attribute of the entity data object, and generating the parameter-level predictive parameter value based on a comparison between (i) the entity-level predictive parameter value and (ii) one or more historical entity-level predictive parameter values corresponding to the entity-level predictive parameter value; applying an optimization model to the cohort-level optimization dataset to generate an iterative candidate output for a constraint set combination; and providing a target output based on a comparison between the iterative candidate output and one or more second iterative candidate outputs respectively corresponding to one or more second constraint set combinations.

Example 19. The one or more non-transitory computer-readable media of example 18, wherein the cohort-level optimization dataset further comprises an entity-level predictive parameter weight.

Example 20. The one or more non-transitory computer-readable media of any of examples 18 or 19, wherein determining the iterative candidate output from the cohort-level optimization dataset comprises performing an optimization iteration for the constraint set combination by minimizing a linear objection loss function defined by the constraint set combination.

Example 21. The computer-implemented method of example 1, wherein the method further comprises training the machine learning ensemble model.

Example 22. The computer-implemented method of example 21, wherein the training is performed by the one or more processors.

Example 23. The computer-implemented method of example 21, wherein the one or more processors are comprised in a first computing entity; and the training is performed by one or more other processors comprised in a second computing entity.

Example 24. The system of example 12, wherein the one or more processors are further configured to train the machine learning ensemble model.

Example 25. The system of example 24, wherein the one or more processors are comprised in a first computing entity; and the machine learning ensemble model is trained by one or more other processors comprised in a second computing entity.

Example 26. The one or more non-transitory computer-readable storage media of example 18, wherein the instructions further cause the one or more processors to train the machine learning ensemble model.

Example 27. The one or more non-transitory computer-readable storage media of example 26, wherein the one or more processors are comprised in a first computing entity; and the machine learning ensemble model is trained by one or more other processors comprised in a second computing entity.

1. A computer-implemented method comprising:
generating, by one or more processors, a cohort-level optimization dataset that comprises an entity-level predictive parameter value and a parameter-level predictive parameter value for an entity data object of a set of entity data objects by:
generating, using a machine learning ensemble model, the entity-level predictive parameter value for the entity data object based on an entity attribute of the entity data object, and
generating the parameter-level predictive parameter value based on a comparison between (i) the entity-level predictive parameter value and (ii) one or more historical entity-level predictive parameter values corresponding to the entity-level predictive parameter value;
applying, by the one or more processors, an optimization model to the cohort-level optimization dataset to generate an iterative candidate output for a constraint set combination; and
providing, by the one or more processors, a target output based on a comparison between the iterative candidate output and one or more second iterative candidate outputs respectively corresponding to one or more second constraint set combinations.

2. The computer-implemented method of claim 1, wherein the target output identifies a subset of entity data objects from the set of entity data objects and a subset of entity-level predictive parameter values from a set of entity-level predictive parameter values of the cohort-level optimization dataset.

3. The computer-implemented method of claim 2, wherein the computer-implemented method further comprises:
receiving, via a user interface accessible to a user device, a resource allocation request comprising a cohort identifier;
identifying the set of entity data objects based on the cohort identifier; and
responsive to the resource allocation request, modifying the user interface to identify the subset of entity data objects from the set of entity data objects.

4. The computer-implemented method of claim 3, wherein each of the subset of entity-level predictive features is associated with a prediction-based action and the computer-implemented method further comprises initiating, using the user interface, a prediction-based actions associated with one of the subset of entity-level predictive features.

5. The computer-implemented method of claim 4, wherein the prediction-based action comprises administering a diabetes medication.

6. The computer-implemented method of claim 1, further comprising:
receiving, from a user device, a resource allocation response that identifies an observed outcome associated with the target output;
modifying a labeled training dataset based on the resource allocation response and the target output; and
training a portion of the machine learning ensemble model based on the labeled training dataset.

7. The computer-implemented method of claim 6, wherein the machine learning ensemble model comprises an engagement prediction model and a plurality of activity-specific prediction models and the engagement prediction model is trained using the labeled training dataset.

8. The computer-implemented method of claim 7, wherein each of the plurality of activity-specific prediction models is trained, using one or more supervisory training techniques, based on an activity-specific labeled training dataset of the plurality of activity-specific prediction models.

9. The computer-implemented method of claim 1, wherein the cohort-level optimization dataset further comprises an entity-level predictive parameter weight.

10. The computer-implemented method of claim 1, wherein the cohort-level optimization dataset comprises a dependent parameter corresponding to the entity-level predictive parameter value and the parameter-level predictive parameter value and the constraint set combination defines a linear objective loss function for optimizing the dependent parameter.

11. The computer-implemented method of claim 1, wherein determining the iterative candidate output from the cohort-level optimization dataset comprises:
performing an optimization iteration for the constraint set combination by minimizing a linear objective loss function defined by the constraint set combination.

12. A system comprising:
one or more processors; and
one or more memories storing processor-executable instructions that, when executed by the one or more processors, cause the one or more processors to perform operations comprising:
generating a cohort-level optimization dataset that comprises an entity-level predictive parameter value and a parameter-level predictive parameter value for an entity data object of a set of entity data objects by:
generating, using a machine learning ensemble model, the entity-level predictive parameter value for the entity data object based on an entity attribute of the entity data object, and
generating the parameter-level predictive parameter value based on a comparison between (i) the entity-level predictive parameter value and (ii) one or more historical entity-level predictive parameter values corresponding to the entity-level predictive parameter value;
applying an optimization model to the cohort-level optimization dataset to generate an iterative candidate output for a constraint set combination; and
providing a target output based on a comparison between the iterative candidate output and one or more second iterative candidate outputs respectively corresponding to one or more second constraint set combinations.

13. The system of claim 12, wherein the target output identifies a subset of entity data objects from the set of entity data objects and a subset of entity-level predictive parameter values from a set of entity-level predictive parameter values of the cohort-level optimization dataset.

14. The system of claim 13, wherein the one or more operations further comprise:
receiving, via a user interface accessible to a user device, a resource allocation request comprising a cohort identifier;
identifying the set of entity data objects based on the cohort identifier; and
responsive to the resource allocation request, modifying the user interface to identify the subset of entity data objects from the set of entity data objects.

15. The system of claim 14, wherein each of the subset of entity-level predictive features is associated with a prediction-based action and the computer-implemented method further comprises initiating, using the user interface, a prediction-based actions associated with one of the subset of entity-level predictive features.

16. The system of claim 15, wherein the prediction-based action comprises administering a diabetes medication.

17. The system of claim 12, wherein the one or more operations further comprise:
receiving, from a user device, a resource allocation response that identifies an observed outcome associated with the target output;
modifying a labeled training dataset based on the resource allocation response and the target output; and
training a portion of the machine learning ensemble model based on the labeled training dataset.

18. One or more non-transitory computer-readable media storing processor-executable instructions that, when executed by one or more processors, cause the one or more processors to perform operations comprising:
generating a cohort-level optimization dataset that comprises an entity-level predictive parameter value and a parameter-level predictive parameter value for an entity data object of a set of entity data objects by:
generating, using a machine learning ensemble model, the entity-level predictive parameter value for the entity data object based on an entity attribute of the entity data object, and
generating the parameter-level predictive parameter value based on a comparison between (i) the entity-level predictive parameter value and (ii) one or more historical entity-level predictive parameter values corresponding to the entity-level predictive parameter value;
applying an optimization model to the cohort-level optimization dataset to generate an iterative candidate output for a constraint set combination; and
providing a target output based on a comparison between the iterative candidate output and one or more second iterative candidate outputs respectively corresponding to one or more second constraint set combinations.

19. The one or more non-transitory computer-readable media of claim 18, wherein the cohort-level optimization dataset further comprises an entity-level predictive parameter weight.

20. The one or more non-transitory computer-readable media of claim 18, wherein determining the iterative candidate output from the cohort-level optimization dataset comprises performing an optimization iteration for the constraint set combination by minimizing a linear objection loss function defined by the constraint set combination.
